(19) United States
(12) Patent Application Publication
(10) Pub. No.: US 2013/0183642 A1
(43) Pub. Date: Jul. 18, 2013

(54) SYSTEM AND METHOD FOR DISPLAYING RECIPES VISUALLY

(71) Applicant: Michael C. Wan, Sharon, MA (US)

(72) Inventor: Michael C. Wan, Sharon, MA (US)

(73) Assignee: Apperax LLC, Sharon, MA (US)

(21) Appl. No.: 13/349,544

(22) Filed: Jan. 12, 2012

(51) Int. Cl. G09B 19/00

(52) U.S. Cl. 434/127

(57) ABSTRACT

A recipe system for simulating an operational environment of a food establishment for guiding a user, such as an employee, to prepare recipes in the actual operational environment. The user may be guided through each step of preparation of a product from a recipe. The recipe system may also be used for training a user to learn a layout of ingredients, and memorize recipes for meals and drinks prepared using the ingredients. The recipe system may allow the user to interact with the recipe system to provide user input to simulate preparation of a meal. The recipe system may track time required by the user to prepare a product and adjust a training process based on user's performance. The recipe system can further be used to simulate different layouts of the operational environment and assess efficiency of each layout by receiving user input simulating preparation of recipes using the layout.

### BACKGROUND

Success and profitability of a food establishment depend on how fast and accurately a customer is served with a requested meal. Customers may be particularly sensitive to how promptly their orders arrive in a restaurant, café, bar or other eating establishment which offers meals to a large volume of customers that do not expect to spend an extended time in the establishment. Also, timeliness of a restaurant may become essential at certain days or times of the day, such as at a lunch time or on Saturday night.

A successful operation of a food establishment, such as a restaurant, may depend on many different factors. Among these factors may be having experienced and skillful employees that are a valuable asset of the restaurant required to maintain a smooth operation of the restaurant, attract new and retain existing customers. However, training a new employee may be a challenging and time-consuming task that requires significant expenses.

A dish or drink typically includes multiple ingredients. To support an entire menu of dishes and drinks, a restaurant may have a large number (e.g., a hundred or more) of different ingredients. It becomes a challenging task to train a new employee to learn multiple recipes and a combination of ingredients used in each of the recipes. New employees may work slowly and make mistakes in preparing recipes, which may decrease efficiency of a restaurant and reduce customer satisfaction, thus affecting the profitability of the business.

To train a new employee, a restaurant typically engages one or more existing, more experienced employees. Such approach, however, may lead to a loss of productivity of the restaurant because both valuable time and resources are expended on the training, without an immediate return to the investment. Furthermore, many restaurants have a high turnover of employees, which exacerbates the need for training new employees efficiently and with low cost.

Another factor that affects the efficiency of operation of a restaurant relates to a layout of ingredients for preparing a meal or drink. The layout may affect the speed with which an employee can complete an order. An inefficient layout of ingredients may slow down even an experienced employee, and may be a challenging bottleneck for a new employee.

The foregoing is a non-limiting summary of the invention, which is defined by the attached claims.

### SUMMARY

A recipe system for simulating preparation of a product in accordance with a recipe may be provided in a computerized form. The recipe system may have a graphical user interface depicting a product preparation area. A user may then interact with the user interface, either observing steps in preparing the recipe indicated by the recipe system or providing input indicating what the user believes are steps in preparing the product.

The product may be a product in the food service industry, such as a food or beverage item. The product preparation area may be a portion of a kitchen or bar where a food or beverage item might be prepared.

The recipe system may operate in one or more modes. Some modes of operation may support training of employees to prepare products, such as by showing the employee steps in preparing a product in accordance with a recipe, including what ingredients are used in the recipe, locations of each ingredient in the product preparation area and the amounts of each ingredient to use. This mode may be used within the food preparation area, to guide a user through the preparation of a product, or outside of the food preparation area, to aid the user in learning how to prepare products according to one or more recipes.

Alternatively or additionally, the recipe system may receive user input indicating the user's beliefs of ingredients to combine in accordance with the recipe, with the recipe system providing an indication when the user input indicates an incorrect understanding of the preparation. Such modes also may be used either inside or outside the product preparation area. When used outside the product preparation area, the recipe system may be used for training a user to prepare products. Some modes of operation may support assessment of a user's ability to make products according to defined recipes. The assessment may be based on the number of steps, or other parts, of a recipe incorrectly identified. Alternatively or additionally, other factors, such as timeliness, may be assessed through use of the recipe system.

The assessment may be geared at determining the competence of an individual user to prepare products according to a recipe or recipes in a book. An individual assessment may determine the individual's accuracy or timeliness in preparing one or more recipes. Alternatively or additionally, the assessment may be geared to determining the effectiveness of a layout of a product preparation area. In that case, performance attributes of one or more users may be measured for different configurations of the product preparation area such that the impact of layout on performance may be assessed, possibly leading to design or selection of an improved layout of a product preparation area.

The recipe system may be implemented as an application for a computer with a touch screen or other suitable user interface. The application may be architected to facilitate one or more of: simple programming, simple modification of recipes or ingredients, and a response, through a graphics-intensive user interface.

In some embodiments, the application may be configured using data structures representing possible ingredients in a product preparation area. Each data structure may include information about the ingredient, such as its units of measure. In addition, the data structure may include one or more images of the item and information that defines how and what portion of that image is displayed to represent the product preparation area. A position within a hierarchy of display layers may also be associated with each image. The stored information allows an appropriate display to be quickly rendered, even if a user pans, zooms or otherwise provides input indicating different portions of the product preparation area to be displayed.

One or more display items may be included to depict, in an intuitive fashion, steps in preparing a product according to a recipe. These display items for example, may include a tipping bottle, to represent selecting an amount of a liquid ingredient for a product.

In one aspect, embodiments of the invention relate to a method of operating a computing device. The device comprises at least one processor, and the method comprises, with the at least one processor, providing, on a user interface, a graphical representation of an operational environment of a food establishment. The visual representation comprises a layout of a plurality of ingredients. The method also includes, for a recipe associated with a set of ingredients of the plurality of ingredients, interacting with a user to simulate a process of preparation of a product described in the recipe from the set of ingredients, using the graphical representation.

In another aspect, embodiments of the invention relate to a method of operating a computer comprising at least one processor. The method comprises, with the at least one processor providing a graphical representation of a first layout of a plurality of ingredients. The method also includes receiving user input with respect to the graphical representation of the first layout. The user input may indicate selection of a set of ingredients of the plurality of ingredients to simulate preparation of at least one recipe associated with the set of ingredients. In addition, the method may include modifying the graphical representation of the first layout based on the received user input to provide a graphical representation of a second layout. At least one ingredient from the plurality of ingredients may have a position in the graphical representation of the second layout that is different from a position of the at least one ingredient in the graphical representation of the first layout.

In yet another aspect, embodiments of the invention may relate to a method of providing a user interface that involves creating at least one data structure representing an item in a visual representation of an operational environment of a restaurant. The at least one data structure may comprise a plurality of parameters. The method may include, with at least one processor, accessing the plurality of parameters to create a representation of the item on the user interface and interacting with a user to receive user input with respect to the representation of the item on the user interface.

In another aspect, embodiments of the invention may relate to a system for simulation of recipe preparation. The system may comprise a device comprising at least one processor configured to implement a method of simulating preparation of a recipe in an operational environment of a restaurant. The method may comprise providing a graphical representation of the operational environment comprising a plurality of ingredients. In a first operating mode, the device may interact with a user to guide the user through preparation of at least one recipe from at least one of the plurality of ingredients, using the graphical representation. In a second operating mode, the device may interact with the user to train the user to prepare the at least one recipe from at least one of the plurality of ingredients, using the graphical representation.

The foregoing is a non-limiting summary of the invention, which is defined by the appended claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B illustrate schematically examples of a restaurant in which some embodiments may be implemented;

FIG. 1C is a schematic representation of a layout of a drink assembly station in a restaurant that may be simulated in accordance with some embodiments;

FIG. 2 is a schematic representation of a layout of ingredients in a food establishment used in the recipe system, in accordance with some embodiments;

FIG. 3 illustrates schematically an example of a graphical representation of an operational environment of a food establishment and food recipes displayed on a user interface provided by the recipe system, in accordance with some embodiments;

FIGS. 4-8 illustrate schematically a modification of the user interface of FIG. 3 during a process of simulation of preparation of a recipe selected from the food recipes shown in FIG. 3, in accordance with some embodiments;

FIG. 9 illustrates schematically an example of a graphical representation of an operational environment of a food establishment and drink recipes displayed on a user interface provided by the recipe system, in accordance with some embodiments;

FIGS. 10-13 illustrate schematically a modification of the user interface of FIG. 9 during a process of simulation of preparation of a recipe selected from the drink recipes shown in FIG. 9, in accordance with some embodiments;

FIG. 14 is a flowchart illustrating a process of guiding a user through preparation of a recipe, using the recipe system, in accordance with some embodiments;

FIG. 15 is a flowchart illustrating a process of training a user to prepare a recipe using the recipe system, in accordance with some embodiments;

FIG. 16 is a flowchart illustrating a process of simulation and assessment of ergonomics of different layouts of ingredients in a food establishment, in accordance with some embodiments;

FIG. 17 is a schematic diagram of a computing environment in which some embodiments may be implemented; and

FIGS. 18 and 19 illustrate schematically a graphical representation of a “drawer” in an operational environment of a food establishment simulated using the recipe system, in accordance with one embodiment.

### DETAILED DESCRIPTION

The inventors have recognized and appreciated that profitability and success of a food establishment may be improved if the establishment utilizes techniques for simulation of an operational environment of the establishment. In this way, instead of using the actual operational environment for training and thus consuming valuable resources, employees may be trained using the simulation techniques. Also, the simulation techniques may allow evaluating various layouts of ingredients in the operational environment to determine a layout to support efficiency in filling orders.

Accordingly, a recipe system is provided that simulates an operational environment of a food establishment by displaying a visual representation of the environment on a user interface that enables a user to provide input simulating actual preparation of a recipe. The visual representation may resemble the actual operational environment and therefore provide the user with the look and feel of the operational environment that the user will encounter during actual preparation of recipes. Accordingly, various operations associated with food and drink preparation may be simulated using the recipe system. The simulated operational environment may be used to simulate, for differences purposes, actions with respect to preparation of recipes, which may allow saving valuable time and resources of a restaurant business.

The recipe system may operate in multiple operating modes that may allow utilizing a simulation of an operational environment of a food establishment in different ways. The operating modes may include a guidance mode in which a user may employ the recipe system as an instruction manual for preparing recipes. In the guidance mode, the user may utilize the recipe system to look up ingredients and preparation techniques for a desired recipe. Another operating mode may be referred to as a training mode which enables the user to become familiar with an operational environment of a food establishment and learn ingredients in various recipes and techniques for preparation of products using the recipes. The recipe system may also operate in an efficiency evaluation mode in which the recipe system may be used to determine an efficient layout of ingredients in an operational environment of a food establishment.

Each of the guidance, training, and efficiency evaluation modes may have suitable variations and modifications. The recipe system may have a user interface or other control to enable a user to select a desired mode and switch between different modes in a simple manner. Moreover, in some scenarios, the recipe system may operate in more than one mode simultaneously. Furthermore, it should be appreciated that the described recipe system may have any other operating modes that may be used to exploit a simulation of an operational environment of a food establishment in any suitable way.

Conversely, in some embodiments, a device configured to interact with a user as part of a recipe system may be capable of operation in one, or a limited number of possible operating modes. The configuration may be fixed as part of the manufacture of the device or may be controlled through license restriction technology as is known in the art based on the number of modes licensed by the user.

In some embodiments, the recipe system may be used to display a representation of an operational environment of a restaurant on a user interface of a suitable device. The device may be any type of a personal computer, such as a tablet personal computer, a personal digital assistant (PDA), a mobile phone or any other suitable computing device associated with a display and capable of executing the recipe system and displaying a representation of the operational environment on the display. The display may be any suitable type of display. For example, the display may be a touch screen that is configured to receive user input. The user input may be provided to step through a preparation of a recipe (e.g., in the guidance mode). Further, it may simulate selection of ingredients of a recipe and other operations during filling an order (e.g., in the training mode or in the efficiency evaluation mode). A device executing the recipe system may operate in any of the operating modes provided by the recipe system.

Regardless of an operating mode, the recipe system may provide a user interface that may display a representation of an operational environment of a food establishment. The user interface may be programmable and may render the visual representation of the operational environment and/or components of the environment in a manner suitable to a particular operating mode and for a current way the recipe system is used.

The recipe system may also receive in suitable form information on an operational environment of the restaurant, such as a layout of ingredients one or more of which are used in the recipes, so that the recipe system may represent the operational environment on a user interface. The representation may resemble the actual operational environment and reflect a layout of ingredients within the layout. In addition to ingredients for meal or drink preparation, any other suitable components of the operational environment may be represented.

Each recipe may comprise a list of ingredients used in preparation of the recipe, quantity of each ingredient, an order of assembling the ingredients, techniques for further operations on one or more of the ingredients, a presentation of the recipe (i.e., an arrangement of the ingredients on a plate, garnish, etc.). Though, it should be appreciated that the recipe may comprise any other suitable information as embodiments of the invention are not limited in this respect. The information on a recipe may include one or more images of the ingredients, one or more views of a completed recipe and any other suitable information.

In some embodiments, each item used in a visual representation of an operational environment of a food establishment, such as an ingredient, a recipe or any other item, displayed by the recipe system may be represented using a data structure. The data structure created for an item may associate the item with one or more respective images and with any other suitable information used to render a visual representation of the item on a user interface. The data structure may also associate an item with a value indicating one or more locations of the item on the user interface or on a suitable portion of the user interface. The location may be determined with respect to a suitable origin.

The technique of representing the item by the recipe system using a data structure may allow programming the recipe system in a simple manner. It may further support rendering the items on a display screen in a manner that allows adjusting a size of the visual representation of an operational environment of a food establishment to a size of the display screen of a device executing the recipe system.

Furthermore, instead of displaying an entire representation of a layout of ingredients (which may not be feasible when a display screen with a limited screen area is used), the recipe system may display different portions (e.g., view frames) of the visual representation of an operational environment, depending on what portion of the representation is currently used in the simulation of preparation of a product by the user. As user's attention needs to be switched to another portion of the user interface (e.g., when a different ingredient is to be “selected”), another portion of the visual representation may overlay the rest of the representation. This may be done automatically or in response to a suitable user input. For example, a user interface of a device executing the recipe system may receive user input with respect to the visual representation of an operational environment of a food establishment instructing which portion of the representation to display in a current view frame. The recipe system may enable the user to perform any other actions with respect to the visual representation of an operational environment, such as zooming, panning, tilting, rotating, etc.

To enable such hierarchal representation of items within a representation of an operational environment of a food establishment, each item used in the representation may be associated with a value indicating its order in the hierarchy. This value may be recorded in a data structure representing the item.

In some embodiments, to train a user to prepare one or more recipes in the training mode, guide the user through a process of preparation of a recipe in the guiding mode, or to simulate preparation of recipes in an efficiency evaluation mode, one or more recipes may be provided to the recipe system. The recipes may be manually input to the recipe system by a user (e.g., via a user interface) or stored in a storage medium associated with a computing device implementing the recipe system using any other suitable technique. The recipes may be from a menu of the restaurant. The recipe system may also receive information on any modifications to a recipe that a customer may make, such as elimination, addition or substitution of certain ingredients. In response, the recipe system may change the information presented.

The user may “prepare” the recipe by providing input via the user interface with respect to the representation of the layout of ingredients on the user interface. User input may simulate selection of an ingredient. For example, the user may touch an area on the user interface displaying a representation of a certain ingredient, which would simulate “grabbing” of this ingredient in the real operational environment. It should be appreciated that any suitable type of user input may be received to simulate selection of an ingredient and other operations. The type of the user input may depend on capabilities of a computing device executing the recipe system and the user interface. For example, the device may receive user input comprising a user's gesture with respect to the device and interpret this gesture as an action with respect to the simulated operational environment.

In the guidance operating mode, the recipe system may be used as a manual for preparation of recipes. A guided simulation of preparation of recipes may be useful when the user utilizes the recipe system in the actual operational environment as the recipe preparation manual.

The recipe system, when used by an employee to obtain instructions on a certain recipe, allows decreasing an amount of mistakes that a new employee may make while preparing meals in the actual working environment. In this way, instead of getting help from other employee(s) or resorting to other options that may incur additional costs, the user may follow the instructions provided by the recipe system to prepare a meal or drink.

When used for guidance, the recipe system provides to a user a visual representation of an operational environment of a food establishment. The representation may have some features different, as compared to a representation displayed in the training mode. For example, the representation provided in the guidance mode may not include indicators of a user's progress toward a goal related to a preparation of a recipe. Though, the representation may include an indicator of time to help the user to prepare the recipe in a timely manner. Any other suitable indicators may be displayed as well. Moreover, in the guidance operating mode, the recipe system may not require that the user provide input indicating selection of ingredients in the same manner as in the training mode.

When used for guidance and training, the recipe system enables the user to become familiar with an operational environment of a food establishment and learn ingredients in various recipes and techniques for preparation of the recipes. The food establishment is referred to herein by way of example as a restaurant. Though, it should be appreciated that any suitable type of food establishment where a customer may order food and/or drink(s) may be simulated via the recipe system described herein. The operational environment may be any area in the restaurant, such as a food station, kitchen, or any other suitable area having multiple ingredients for preparing different recipes for meals and drinks.

A new employee of a restaurant may use the recipe system to train so as to acquire sufficient skills for filling orders at the restaurant. The training may be performed at a location separate from an operational environment of the restaurant. Furthermore, the user may utilize the recipe system while preparing a meal or drink in the actual operational environment. In such scenarios, the recipe system may guide the user through the process of meal or drink preparation, thus avoiding the need for the user to resort for help of other employees.

Accordingly, equipping a user, such as an employee of a restaurant, with the recipe system allows avoiding the need to engage other employee(s) to train that user. The recipe system therefore allows the restaurant to save valuable resources, such as productive time of its experienced employees that would otherwise be spent on training a new or less experienced employee. The new employee, trained using the recipe system, may become capable of preparing meals independently and at a speed that would make this employee a productive asset of the restaurant.

The recipe system may employ different techniques to assess performance of a user, such as an employee of a restaurant, utilizing the recipe system to learn to prepare different recipes on a menu in the restaurant. Thus, the user may assess his or her progress in training. The recipe system may assess user's performance based on different parameters, such as correctness of user's selection of an ingredient, a selected quantity of the ingredient, a time taken by the user to select one or more ingredients, and any other parameters. Accordingly, the user may continue training using the recipe system until a certain level of performance is achieved, upon which the user may be determined to be sufficiently trained to begin filling actual order in the restaurant.

In operation, during a training process, the recipe system may display recipes for products to a user so that the user can select a recipe to learn. Further, in some embodiments, the recipe system may select a recipe for user to learn, using a suitable algorithm. For example, the recipe system may select a recipe that the recipe system previously determined the user did not “prepare” efficiently. As another example, a recipe selected by the recipe system may be a new recipe, a randomly selected recipe, or a recipe selected in any other suitable manner.

Regardless of the way a recipe is selected, the user may be presented with ingredients used in the recipe to prepare a product. In some embodiments, the recipe system may indicate to the user an order in which to select the ingredients. Any suitable type of indication may be provided for this purpose. For example, a representation of the ingredient to select at a present time may be highlighted with a different color, shaded, or otherwise differentiated from other displayed ingredients within the layout. As the user selects the indicated ingredient, the next ingredient to select may be indicated by the recipe system in a suitable manner. The user may follow such guided process to memorize the ingredients and a way of preparation of the recipe.

In some operating modes, the recipe system may not indicate ingredients for the recipe. Alternatively, the ingredients may be presented, but no hints on an order of selection of the ingredients may be provided. Such representation may be used as part of more advanced stages of training the user—for example, to evaluate user's ability to prepare a product by independently following a recipe. The recipe system may enable the user to provide user input indicating a selection of different options with respect to a training process. Moreover, the recipe system may be configured to adjust the options based on user's performance and other parameters.

In any of the operating modes, when the recipe system presents the ingredients used in a recipe, the recipe system may also present additional information on the recipe that may be useful in learning how to execute the recipe in a real operational environment. Such information may include, for example, a visual representation (e.g., an image) of a completed recipe.

Furthermore, as the user steps through a simulation of a process of preparation of the recipe, any other additional information on the preparation of the recipe may be presented. For example, as the user selects the ingredient, the recipe system may provide any suitable additional information on the ingredient. For example, information on a manner of arranging the ingredient on a plate may be presented. If the recipe is for a drink, the additional information may comprise a representation showing the user how to combine the ingredients with other ingredients of the recipe (e.g., shake, mix, stir, etc.) or process the ingredient (e.g., crush, heat, shake, etc.). It should be appreciated that embodiments of the invention are not limited with respect to information presented by the recipe system in addition to a representation of an ingredient.

In some embodiments, in any of the operating modes, the recipe system may present additional features simulating actions of the user while preparing a recipe. For example, the recipe system may display a representation that enables simulation of selection by the user of a quantity of the ingredient. The representation may be a slide bar or any other visual element that may be modified via user input simulating selection of quantity of the ingredient. In some embodiments, the representation may visually resemble the ingredient being selected and may be modified in response to user input simulating taking certain quantity of the ingredient, with the degree of the modification of the representation corresponding to the quantity. In this way, for example, if the ingredient is a bottle of vodka, the recipe system may display a representation resembling such bottle. The representation may be modified via user input simulating pouring of vodka from the bottle, in which case the representation of the bottle will show a titled bottle. Though, it should be appreciated that any suitable representation indicating user selection of quantity of ingredients may be substituted as embodiments of the invention are not limited in this respect.

The recipe system may track progress of the user and visually indicate evaluation of user's performance as the user provides input simulating preparation of the recipe. User's progress towards different goals may be determined. For example, the recipe system may track the user's progress towards completing a recipe correctly, learning a recipe, learning a collection of recipes (e.g., recipes on a menu of a restaurant) or any other goal.

Accordingly, different indicators of user's progress may be displayed on the user interface. For example, an indicator tracking a time the user is taking to “prepare” a recipe may be represented. The indicator may also show in a suitable way how the time is evaluated. For example, if the time exceeds a certain threshold, the indicator may be modified in a suitable manner. As another example, if the user incorrectly selects an ingredient while preparing a recipe, or performs any other erroneous action, the recipe system may display an indication of an error to the user. Any suitable textual, visual, audible or other type of indicators may be utilized.

The recipe system may also visualize user's performance as the user is training using the recipe system with respect to any other aspects of preparation of the recipes. For example, the recipe system may indicate whether a selected quantity of the ingredient is within a predetermined range. The recipe system may display indicators of user's performance with respect to any suitable aspects of user's actions simulating preparation of the recipe.

In the efficiency evaluation operating mode, the recipe system may be used to evaluate efficiency and ergonomics of different layouts of an operational environment of a restaurant to select a layout for implementing at the operational environment that is determined to be more efficient than other layouts. A layout of the operational environment includes a particular arrangement of different ingredients for preparing recipes and any other suitable items. For example, a layout for a bar may include an arrangement of different ingredients for preparing drinks, such as vodka, beer, juices and fruit for coloring and garnishing of drinks. As another example, a salad bar may include various ingredients for assembling salads. An operational environment (e.g., a kitchen) in a restaurant may have different types of ingredients arranged into a particular layout.

A spatial arrangement of ingredients relative to each other and with respect to one or more employees at the operational environment may affect efficiency of preparing recipes from the ingredients by the employee. For example, ingredients that are used often may be located so that they are easily reachable by the employee. Ingredients that are more exotic and less frequently used in recipes may be located further away from a location of an employee. Furthermore, ingredients that are used together in many recipes may be placed in proximity to each other. Thus, the recipe system may operate in a mode that allows determining an efficient and ergonomic layout of ingredients in a food establishment which may improve overall efficiency and profitability of the establishment.

As a number of ingredients used increases and in a typical scenario where speed of assembling orders is a factor in profitability of a restaurant, a task of efficiently arranging ingredients used in recipes may become complicated. Accordingly, the applicants have recognized and appreciated that the recipe system described herein may be utilized to represent different layouts of ingredients in an operational environment of a restaurant and use the representations to determine the speed with which an employee of the restaurant can prepare recipes on a menu of the restaurant by selecting the ingredients. Accordingly, instead of physically rearranging real ingredients in a restaurant kitchen and involving an employee to prepare multiple recipes to determine an efficient layout of ingredients, the recipe system enables a user to evaluate any number of different simulated layouts quickly and without spending valuable resources.

The representation of each layout on a user interface may simulate a respective real layout of ingredients, and suitable user input received from a user (e.g., an employee) through the user interface may simulate selecting the ingredients. In this way, the speed of the preparation of one or more recipes from ingredients arranged into the simulated layout may be taken as an indicator of efficiency of that layout. Though, it should be appreciated that any other suitable parameter may be used as an indicator of efficiency of a layout.

For each layout of the simulated layouts, if it is determined that one or more employees prepares recipes at a speed lower than a certain threshold speed, the recipe system may be instructed to present a modified layout with different arrangements of ingredients. The layout may be modified based on any suitable factors. For example, the recipe system may implement a technique for automatically determining, based on a menu and/or any other factors, which ingredients to rearrange within the layout. In some embodiments, user input may be received instructing the recipe system which ingredients to rearrange. Additionally or alternatively, in some scenarios, the menu may be modified.

Regardless of a way in which the layout determined to be not sufficiency efficient is modified to represent via the recipe system a modified layout, the efficiency of the modified layout may then also be evaluated. In this way, the recipe system may be used to evaluate efficiency of a number of simulated layouts, by simulating preparation of recipes using each layout, until a desired layout is selected.

In some embodiments, programming techniques may be employed that allow programming the recipe system in an easy and intuitive manner. In this way, a data structure may be created for each item in the simulated operational environment, such as an ingredient, a recipe and any other item. Such representation of an item may allow displaying ingredients on a user interface in a suitable manner.

A data structure created for each item may associate the item with one or more images of the item, any other suitable information on the item, and a set of values indicating a location of a representation of the item within on a user interface or a portion of the user interface displaying a visual representation of an operational environment of a food establishment. The values may indicate a distance from an origin, which may be any suitable reference point within the user interface or its portion. For example, an upper left corner of the user interface may be taken as the origin. Though, any other implementations may be substituted as embodiments of the invention are not limited in this respect. The item may be associated with more than one location.

In some embodiments, a data structure may be created for a recipe. The data structure may be, for example, an object that may be instantiated by allocating a memory location for an instance of the object. The data structure may comprise parameters defining the recipe, with each parameter associated with a set of values. When an instance of the data structure is created, the parameter may be assigned a value from the set of values. For example, parameters of a recipe may comprise its name, names of the ingredients, one or more modifications to the recipe, one or more images of a completed product, and one or more time parameters indicating duration of time acceptable for the preparation of the recipe. A data structure for a recipe may be associated with multiple sets of values each indicating a location of an ingredient from ingredients used in the recipe.

Data structures may also be created for ingredients. A data structure representing an ingredient may comprise related parameters, such as a name of the ingredient, a quantity of the ingredient, a unit of the quantity (e.g., a piece, a slice, an ounce, etc.), a category of the ingredient, related images(s), and one or more actions associated with preparation of the ingredient (e.g., layering, shaking, etc.). Though, it should be appreciated that any other parameters may be defined for an ingredient or a recipe.

In some embodiments, a user interface used to display the recipe system may have a size that does not allow displaying in a single view (e.g., without scrolling down) a representation of an entire layout of ingredients of a restaurant. In such embodiments, one or more ingredients used in a recipe that the user is currently being guided to prepare or is training to prepare using the recipe system may be displayed in a hierarchical order. In this way, a representation of a portion of the user interface displaying one or more items currently viewed by the user as part of a “preparing” a recipe (i.e., current view frame) may overlay other portions in the layout so that the user is enabled to view the item that is currently in focus. For example, an image of an ingredient to select from the used ingredients may overlay images of other ingredients in the layout so that the user can view the image and, depending on a mode of operation, provide input with respect to the image. To display items in a hierarchical order, each item may be associated with a value indicating its order in the hierarchy. This value may be recorded, for example, in a data structure representing the item. The order may be based on an order of employing the item in simulation of preparation of one or more recipes or on any other suitable factors.

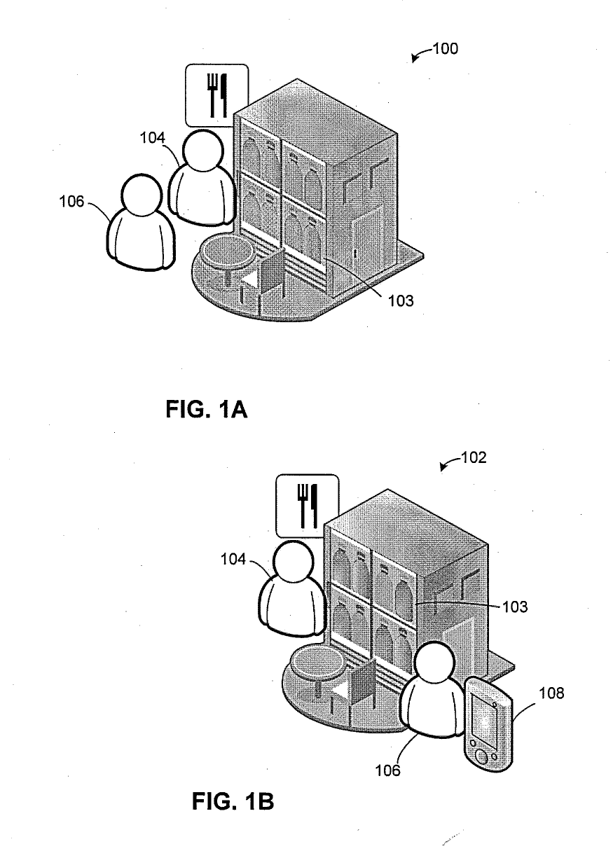

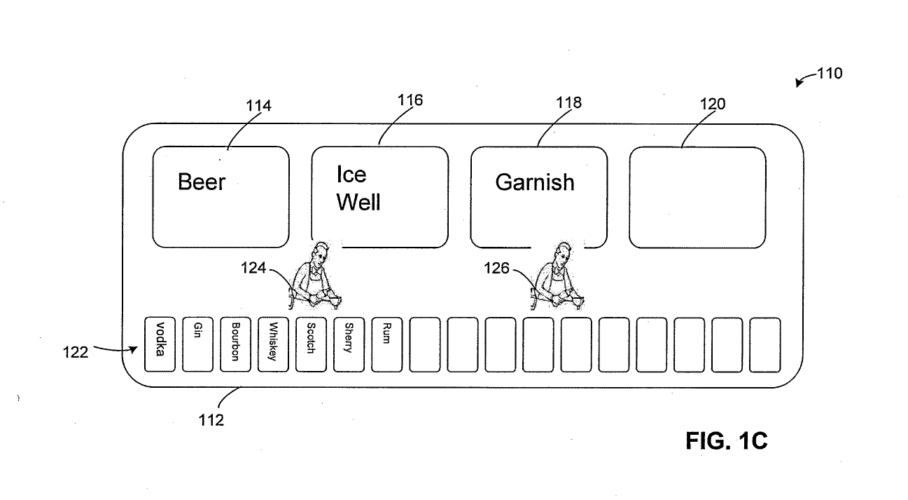

FIG. 1A illustrates an example of a food establishment 100 having an operational environment 103. Food establishment 100 may be a restaurant, café, bar or any other food establishment. Operational environment 103 may include multiple ingredients used in recipes on a menu in food establishment 100.

One or more employees may be working in food establishment 100. In this respect, FIG. 1A illustrates by way of example that an employee 104 and an employee 106 may be working in food establishment 100. In this example, employee 104 may be a more experienced employee, whereas employee 106 may be a less experienced employee. Food establishment 100 many have multiple recipes on a menu and, to become valuable for operating of food establishment 100, employee 106 may need to learn ingredients of multiple recipes.

If conventional approaches to training employees in food establishment 100 are utilized, more experienced employee 104 may need to train less experienced employee 106 to prepare different recipes. Furthermore, employee 106 may be given information on ingredients in each recipe to learn. For example, employee 106 may be given a list of ingredients printed on a paper or otherwise presented in a textual format. A process of learning the recipes by employee 106 using such format of presentation of ingredients may be time consuming and cost ineffective. Employee 106 may also spend valuable resources of food establishment 100 while slowly learning the recipes. Expending time of more experienced employee 104 to train employee 106 may further decrease efficiency of food establishment 100.

FIG. 1B illustrates an example of a food establishment 102 in which some embodiments may be implemented. Food establishment 102 may be food establishment 100 shown in FIG. 1A or any other food establishment. As shown in FIG. 1B, in food establishment 102, employee 106 may operate a computing device 108 that may execute a recipe system in accordance with some embodiments of the invention. Device 108 may be a PDA, a tablet PC or any other suitable computing device. The recipe system may simulate operational environment 103 and may operate in a number of different modes.

Device 108 executing the recipe system may be used by employee 106 in operational environment 103. In such embodiments, device 108 may have a display that may be located in the vicinity of a workplace of employee 106 so that employee 106 may view a visual representation of a process of preparation of the recipe while actually preparing the recipe. When equipped with the recipe system, employee 106 may prepare a recipe in a time and cost efficient manner.

In a guidance mode, the recipe system may operate as an interactive reference manual and may thus guide a user, such as employee 106, through a process of preparation of a recipe by indicating to the user a location within operational environment 103 of each of the ingredients used in the recipe. The location may be indicated via a simulation of operational environment 103 including a visual representation of operational environment 103. Thus, the user may look up a location of each ingredient used in the recipe in the representation of operational environment 103 and determine where that ingredient is located in the actual operational environment 103. Any other suitable information comprising visual cues on preparation of a recipe may be provided by the recipe system to the user. In this way, employee 106 may utilize the recipe system to independently prepare any recipe on a menu in food establishment 102, without resorting to help from employee 104 (that, in turn, may continue his/her tasks).

In some embodiments, employee 106 may utilize the recipe system executed by device 108 for training, which may be done outside of operational environment 103. In the training mode, employee 106 may learn preparation of one or more recipe by using a simulation by the recipe system of operational environment 103.

It should be appreciated that the recipe system may operate in any other suitable modes.

Operational environment 103 may be any suitable operational environment. For example, the operational environment may be any area in the restaurant, such as a food station, kitchen, or any other suitable product preparation area having multiple ingredients for preparing different recipes for meals and drinks. An example of an operational environment 110 that may be simulated by the recipe system is shown in FIG. 1C.

FIG. 1C illustrates a layout of a drink assembly station 112 in a restaurant that may be simulated via the recipe system in accordance with some embodiments. Drink assembly station 112 of operational environment 110 includes different items such as beer 114, ice well 116, garnish 118 and any other items schematically shown by an area 120. Beer 114 and garnish 118 may include any suitable ingredients (not shown).

Drink assembly station 112 may further include multiple other ingredients—as an example, liquors 122 are shown in FIG. 1C. Though, it should be appreciated that the recipe system may simulate an operational environment of a food establishment that may be any type of a product preparation area, as embodiments of the invention are not limited in this respect. FIG. 1C illustrates schematically that employees, such as employee 124 and employee 126 (e.g., employees 104 and 106 in FIG. 1A), may operate at drink assembly station 112 of operational environment 110. It should be appreciated, however, that any number of employees (e.g., one or more than two) may operate in an operational environment that may be simulated by the recipe system described herein.

To simulate an operational environment, the recipe system may associate each item in the recipe system (e.g., an ingredient) with a location within a simulated operational environment. The location may be used to display a representation of the item and track the representation in the simulated operational environment.

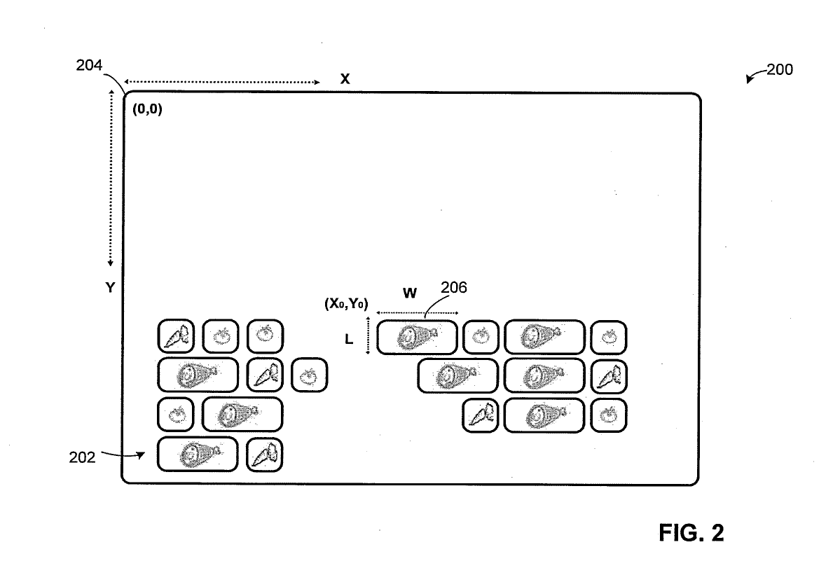

FIG. 2 illustrates a schematic representation of a layout 200 of ingredients in an operational environment of a food establishment simulated by the recipe system. In this example, each of ingredients 202 within layout 200 may be associated with a location in layout 200.

FIG. 2 shows schematically that layout 200 may have a reference point, such as an origin 204. Layout 200 having such origin 204 may include ingredients or any other items. A location of each ingredient from ingredients 202 may be determined in an XY coordinate system as a distance from a location (0,0) of this point 204. Thus, a simulated ingredient 206 may have a location (X₀, Y₀) relative to the location (0,0) of origin point 204. Ingredient 206 may be also associated with a width (W) and a length (L) of a visible area occupied by its representation in layout 200, which may be offsets from its location (X₀, Y₀). It should be appreciated that origin point 204 is shown in the upper left corner of layout 202 by way of example only, as origin point 204 may be located in any other position within layout 200 or other portion of a graphical user interface displaying the simulated operational environment. Similarly, the location (X₀, Y₀) of ingredient 206 is shown as the upper left corner of the representation of the ingredient by way of example only.

Furthermore, it should be appreciated that the two-dimensional coordinate system is shown in FIG. 2 by way of example only, as embodiments are not limited in this respect. In some embodiments, a three- or higher-dimensional coordinate system may be utilized. In FIG. 2, ingredient 206 is associated with (X₀, Y₀) relative to the location (0,0) of origin point 204 and the visible area occupied (L, W). In embodiments employing a three-dimensional coordinate system, however, an ingredient or other item in a layout may be specified as having a position (X₀, Y₀,Z₀) relative to an origin and occupying an area (L, W, H), where H represents a height of a representation of the ingredient. Any other representation of items in a simulated layout may be substituted.

It should also be appreciated that the representation of ingredient 206 having a rectangular shape is shown in FIG. 2 by way of example only, as the representation may be circular, oval or may have any other shape or form in a two- or higher-dimensional coordinate system. Accordingly, the size and shape of a visible area of an item within a simulated layout of an operational environment of a food establishment may be specified in any suitable ways. Any suitable mathematical expressions may be used to specify the visible area. The representation of an item may be an image, a drawing, or any other suitable representation of the item.

Regardless of a way in which a location of an ingredient is defined within a simulated operational environment of a food establishment, the location may be used to track the representation of the ingredient as the ingredient is displayed on a graphical user interface displaying the simulated operational environment. The location may also be used to track the representation of the ingredient as the ingredient is “selected” by user during “preparation” of a recipe that uses the ingredient.

The recipe system may be implemented as an application for computing device which may be associated with a touch screen display. The application may present a simulation of an operational environment of a restaurant or other food establishment through a graphics-intensive user interface. The user interface may be provided by a display that may be located in the vicinity of a working place of a user, such as an employee of the restaurant.

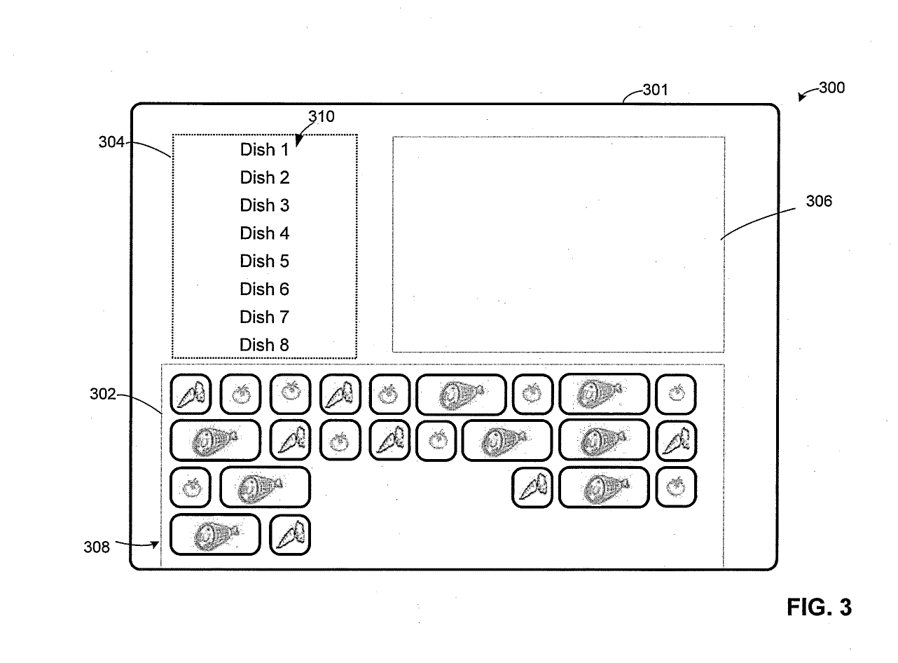

FIGS. 3-8 illustrates schematically an exemplary graphical user interface 300 providing a simulation 301 of an actual operational environment of a food establishment simulated by the recipe system, in accordance with some embodiments. Simulated operational environment 301 may be a graphical representation of the actual operational environment and may be presented via any suitable graphical user interface. For example, a graphical user interface of device 108 (FIG. 1B) may be utilized.

In the guidance mode, the recipe system may guide a user through preparation of a recipe in the actual operational environment using operational environment 301. The user may be an employee of the food establishment or any other type of user. The recipe system allows decreasing an amount of time and resources (e.g., a valuable time of other employee(s) in the food establishment) that the user would otherwise spend on preparation of the recipe, thus increasing an efficiency of the user. This may contribute to the increase in the overall efficiency and profitability of the food establishment.

In the training mode, the recipe system may be utilized by the user to learn preparation of multiple ingredients. Such training process may also decrease costs and increase profitability of the food establishment because the user may be trained to prepare recipes off-site so that he or she may then prepare the recipes on a menu in the food establishment without spending valuable working time on training.

Furthermore, when used for an efficiency evaluation to determine an efficient layout of items in the operational environment, the recipe system may also help to increase the efficiency of the food establishment.

FIG. 3 shows operational environment 301 that may be displayed at the beginning on a process of guiding a user of the recipe system through a preparation of a recipe. As illustrated in FIG. 3, operational environment 301 may include areas, such as areas 302, 304, and 306, each comprising different information. Thus, in the example illustrated, area 302 may include a plurality of ingredients 308 and area 304 may include a plurality of recipes (“Dish 1”-“Dish 8”) 310. Because FIG. 3 illustrates operational environment 301 at the beginning on the process of guiding a user through a preparation of a recipe, area 306 may not display any information. It should be appreciated that operational environment 301 is shown in FIG. 3 by way of example only as the recipe system may present operational environment 301 on graphical user interface 300 in any suitable manner. Furthermore, ingredients 308 and recipes 310 may be presented in other ways, using different visual, textual and other formats.

Recipes 310 presented within operational environment 301 may be provided in any suitable way. For example, recipes 310 may be stored in a suitable manner on a device executing the recipe system (e.g., device 108 in FIG. 1B). In some embodiments, user input may be received to store information on recipes 310 in the device for use by the recipe system. Recipes 310 may be recipes on a menu in a food establishment including an operational environment simulated via operational environment 301. Moreover, one or more of recipes 310 may be modified based on different factors—e.g., when a customer orders a modified recipe due to preference, food allergy or for any other reason.

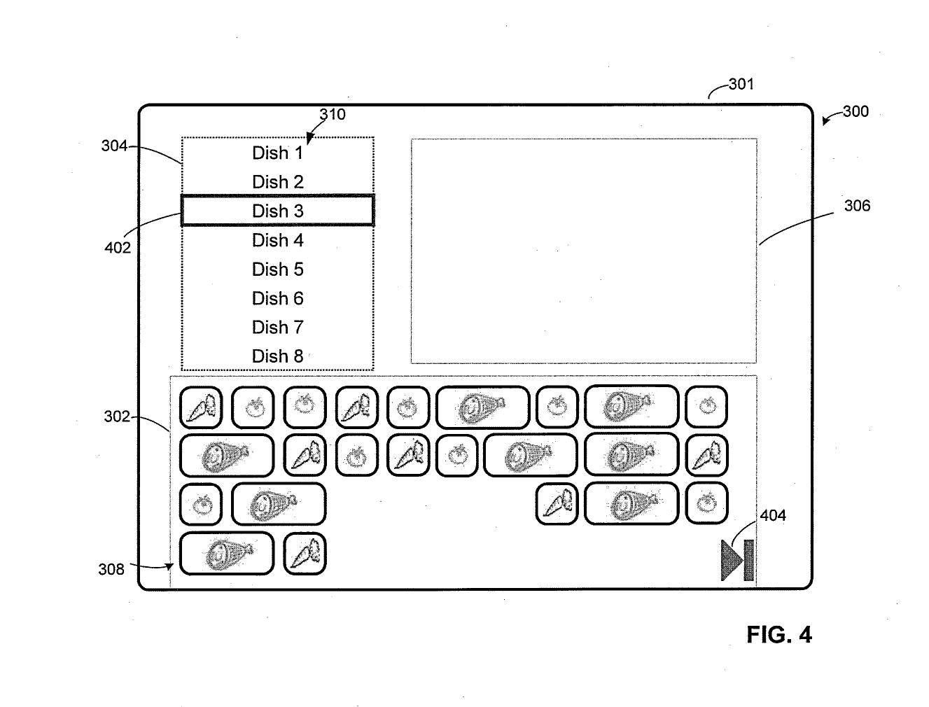

Once ingredients 308 and recipes 310 are presented on the graphical user interface, as shown in FIG. 3, a user, such as an employee of the simulated food establishment, may select a recipe from recipes 310. FIG. 4 shows that a recipe 402 for a product (“Dish 3”) emphasized with a frame may be selected by the user from recipes 310. It should be appreciated that the selection of recipe 402 via user input is shown by way of example only, as a recipe may be selected from recipes 310 in any suitable manner. For example, while in the guidance mode of operation of the recipe system, user input may be received with respect to one or more recipes indicating selection of the recipe(s), in the training mode, a recipe may be selected by the recipe system using a suitable algorithm. A selected recipe may be visually indicated in any suitable manner.

Regardless of the way a recipe is selected, another view of operational environment 301, such as a modified representation of operational environment 301, may be presented. For example, user input with respect to a suitable control, such as a “Next” button 404, may be received instructing the recipe system to present another view of operational environment 301. In the guidance mode and in any other operating mode, such control may be used at any stage of simulated preparation of the recipe, to instruct the recipe system to proceed to a next step of the recipe preparation.

Additionally or alternatively, in some embodiments, another view of operational environment 301 may be presented on graphical user interface 300 in response to the selection of the recipe or any other suitable trigger.

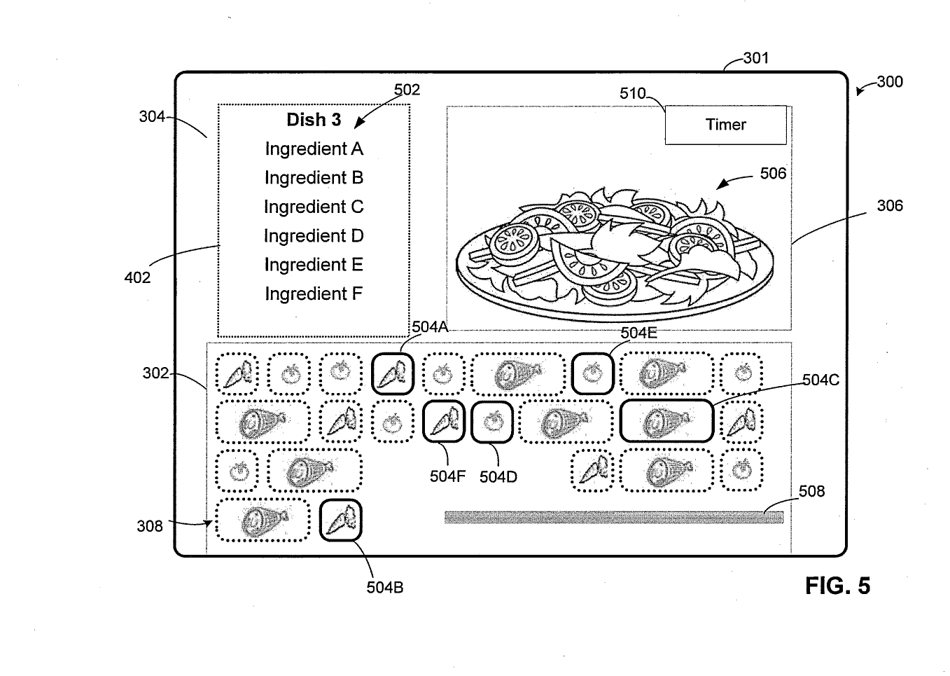

Regardless of the way in which a representation of operational environment 301 after the recipe selection is effected, ingredients used in the recipe to prepare a product may be presented on the graphical user interface. FIG. 5 illustrates that ingredients 502 used in selected recipe 402 for the product “Dish 3” may be displayed. In the example illustrated, Dish 3 includes ingredients 502 shown by way of example as ingredients A, B, C, D, E and F.

FIG. 5 shows that each of the ingredients A, B, C, D, E and F used in recipe 402 may be indicated within ingredients 308 in operational environment 301. Thus, ingredients 504A, 504B, 504C, 504D, 504E and 504F may be indicated in a suitable manner—e.g., visually emphasized or otherwise differentiated from other ingredients in operational environment 301. In any of the operating modes, the visual indication of ingredients 502 used in selected recipe 402 may assist the user interacting with the recipe system in either actual or simulated preparation of recipe 402. Thus, in the guidance mode, the user may be enabled to determine where each of ingredients 502—ingredients A, B, C, D, E and F—is located within the actual operational environment simulated as operational environment 301. In the training and efficiency evaluation modes, the user may be similarly enabled to learn where each of ingredients 502 is located within the actual operational environment and, furthermore, may be enabled to interact with the recipe system by simulating “preparation” of Dish 3 from ingredients 502 in recipe 402.

Any information that may be useful to the user in preparation, either actual or simulated, of selected recipe 402 may be presented on the graphical user interface. For example, in area 306 or in any other location on the user interface, a final look 506 of Dish 3 may be presented or any other information useful at each step of preparation of Dish 3. It should be appreciated that final look 506 of Dish 3 is shown in FIG. 5 only as an example, as any intermediary look of Dish 3 may be presented additionally or alternatively, to assist the user in proper assembling of the product, Dish 3.

Additionally or alternatively, in some embodiments, one or more indicators of a progress towards a completion of the preparation of a product may be displayed. Thus, as shown in FIG. 5, a progress indicator 508 indicating how complete Dish 3 is may be displayed. Progress indicators may be provided in any mode of operation of the recipe system. Though, such indicators may be more extensively used in the training mode where the recipe system is utilized to learn preparation of recipes and the progress indicators indicate to the user user's speed, accuracy and other parameters of user's progress with respect to preparation of the recipe. In any of the operating modes, a timer, shown in FIG. 5 by way of example as a timer 510, may indicate a time that has passed from the beginning of preparation (either actual or simulated) of recipe 402. It should be appreciated that timer 510 may be optional—for example, it may not be presented in the guidance mode of operation of the recipe system.

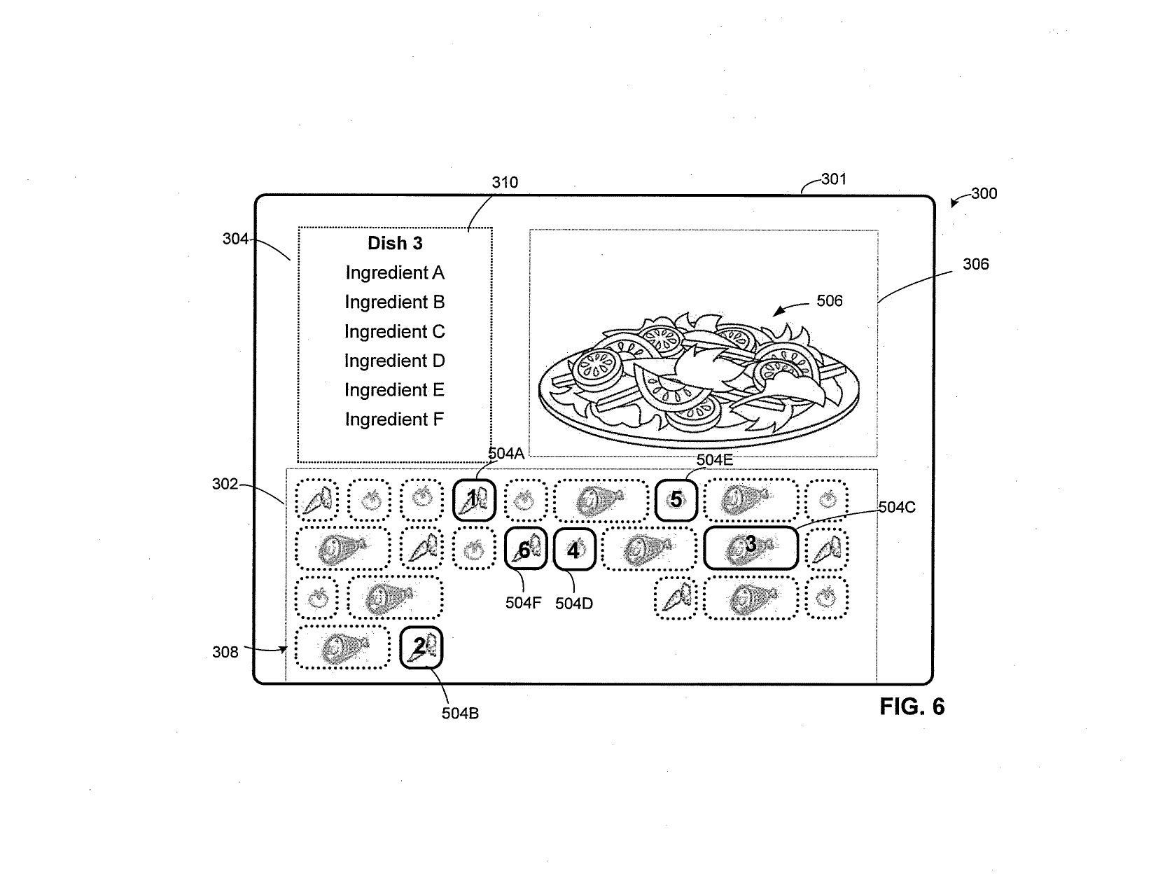

Next, in the exemplary illustration of preparation of recipe 402, an order of selecting of ingredients 502 used in recipe 402 may be indicated in operational environment 301 in a suitable manner. Accordingly, FIG. 6 illustrates that a representation of each of ingredients 502 may be marked with a number indicating the order of selection of that ingredient. In this example, recipe 402 requires that ingredient 504A be selected first, ingredient 504B be selected second, ingredient 504C be selected third, ingredient 504D be selected fourth, ingredient 504E be selected fifth, and ingredient 504F be selected sixth. It should be appreciated that, although FIGS. 5 and 6 show all of the ingredients 504A-504F and the order of their selection for the preparation of recipe 402 simultaneously, each of the ingredients, and therefore its order of selection, may be indicated at a separate step. In this way, the user may step through the graphical representation comprising operational environment 301 (e.g., by using “Next” button 404 or any other control), where each step would have different ingredient among ingredients 308 indicated to the user. Such stepwise representation of preparation of a recipe may be used in the guidance mode or in any other operating mode of the recipe system.

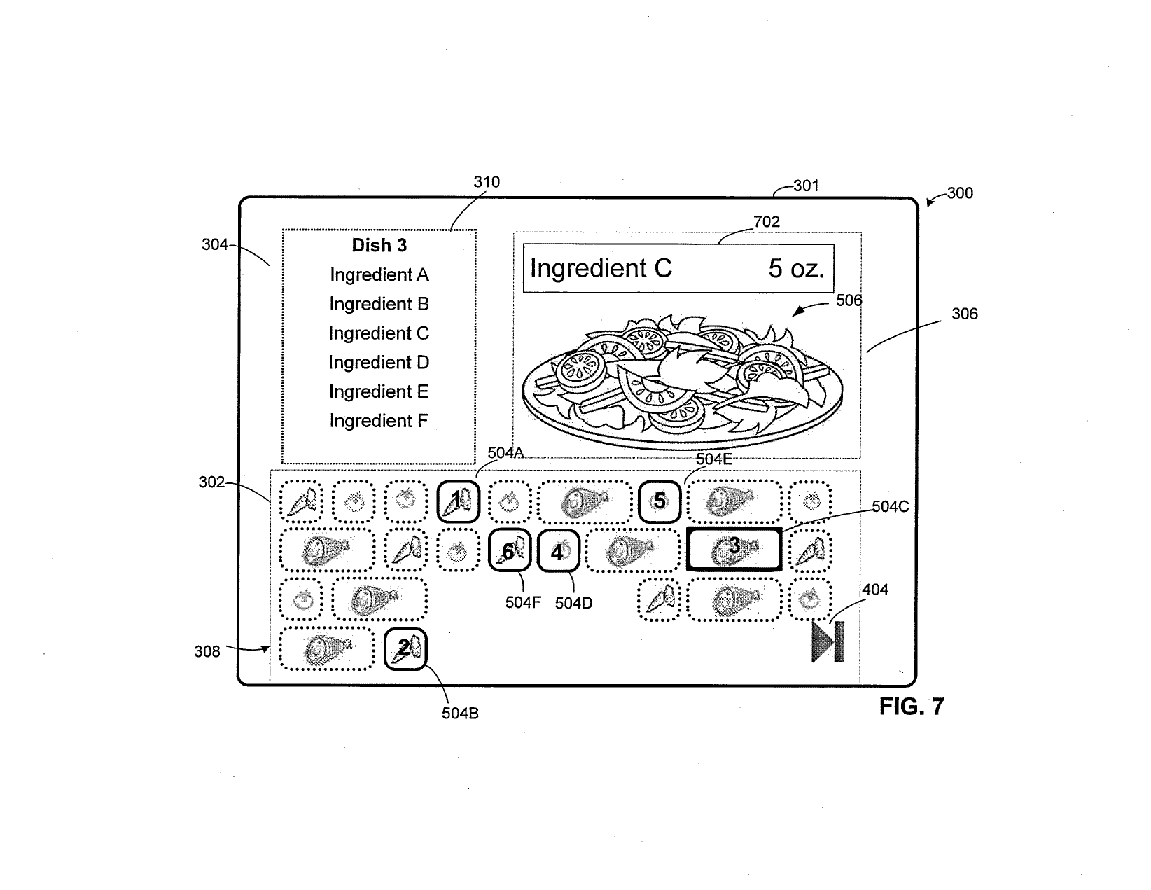

As discussed above, additional information on each ingredient used in the recipe may be presented on graphical user interface 300 to assist the user in either actual preparation of the recipe or in the process of simulation of preparation of the recipe. FIG. 7 illustrates an example where ingredient 504C (“ingredient C”) is visually indicated and additional information on the ingredient, such an amount of this ingredient used in the recipe (“5 oz.”), may be displayed on graphical user interface 300. It should be appreciated that the representation shown in FIG. 7 is exemplary only and that similar information with respect to ingredients A and B may be displayed prior to the representation in FIG. 7.

Any other information may be presented in association with the ingredient, which is not shown for the sake of simplicity. For example, if recipe 402 requires that ingredient C be manipulated in any way (e.g., crushed, cut, heated, shaken, stirred, mixed with any other ingredient(s), garnished, arranged in a particular manner on a plate, etc.), the information on these procedure(s) may be provided to the user via graphical user interface 300. The information may be provided in a manner that simplifies to the user the process of preparation of the recipe.

When the user no longer requires information with respect to ingredient C of recipe 402 presented in FIG. 7, other representation of operational environment 301 may be presented. For example, user input with respect to a control, such as button 404, may be received instructing the recipe system to present a next view of operational environment 301.

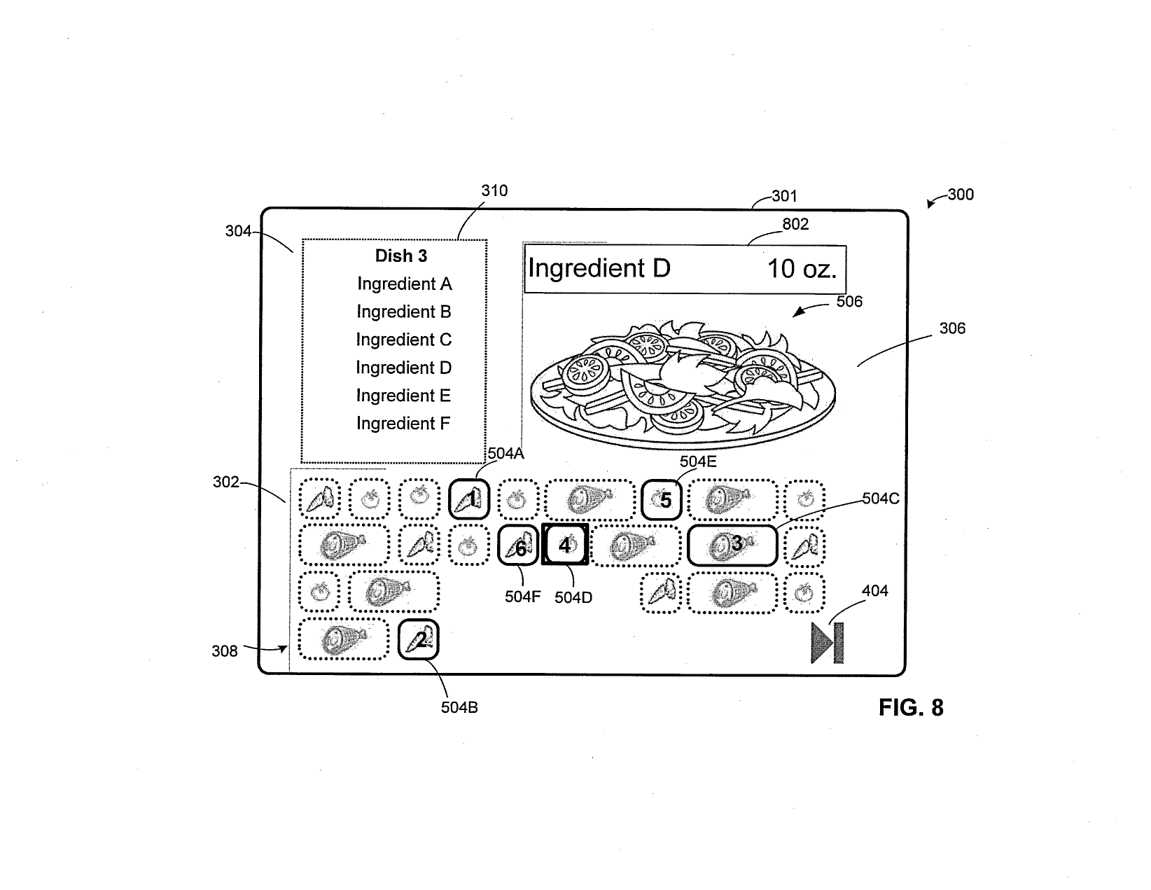

Accordingly, a view of operational environment 301 shown in FIG. 8 may be presented. This view may provide to the user information on another ingredient used in recipe 402, ingredient D labeled as 504D in FIGS. 5-8. Any suitable information associated with preparation of ingredient D, such as its amount used in recipe 402 (“10 oz.”), may be presented (802). FIGS. 7 and 8 thus illustrate that information on each of ingredient used in a recipe may be presented to the user on a different view of operational environment 301. Though, it should be appreciated that other ways of presenting information on ingredients used in a recipe may be substituted. For example, information on more than one ingredient may be presented simultaneously, particularly if the ingredients are combined in some manner in the product. Generally, in the guidance mode, the recipe system may present information on a recipe for a product in a manner that guides a user through each step of preparation of the recipe in the actual operational environment of a food establishment. As a result, the user equipped with a device executing the recipe system may look up a desired recipe in the recipe system, such as a recipe for a product ordered by a customer, and prepare the recipe by following a graphical representation of the process provided by the recipe system.

Furthermore, in the training mode of operation of the recipe system, information on an ingredient used in a recipe, such as the information shown in FIGS. 5-8 may be presented to the user as the user interacts with the system to simulate preparation of the recipe. The information on an ingredient may be presented either in response to suitable user input (e.g., a selection of the ingredient on the graphical user interface) or in response to other triggers, such as a completion of a previous step of preparation of the recipe.

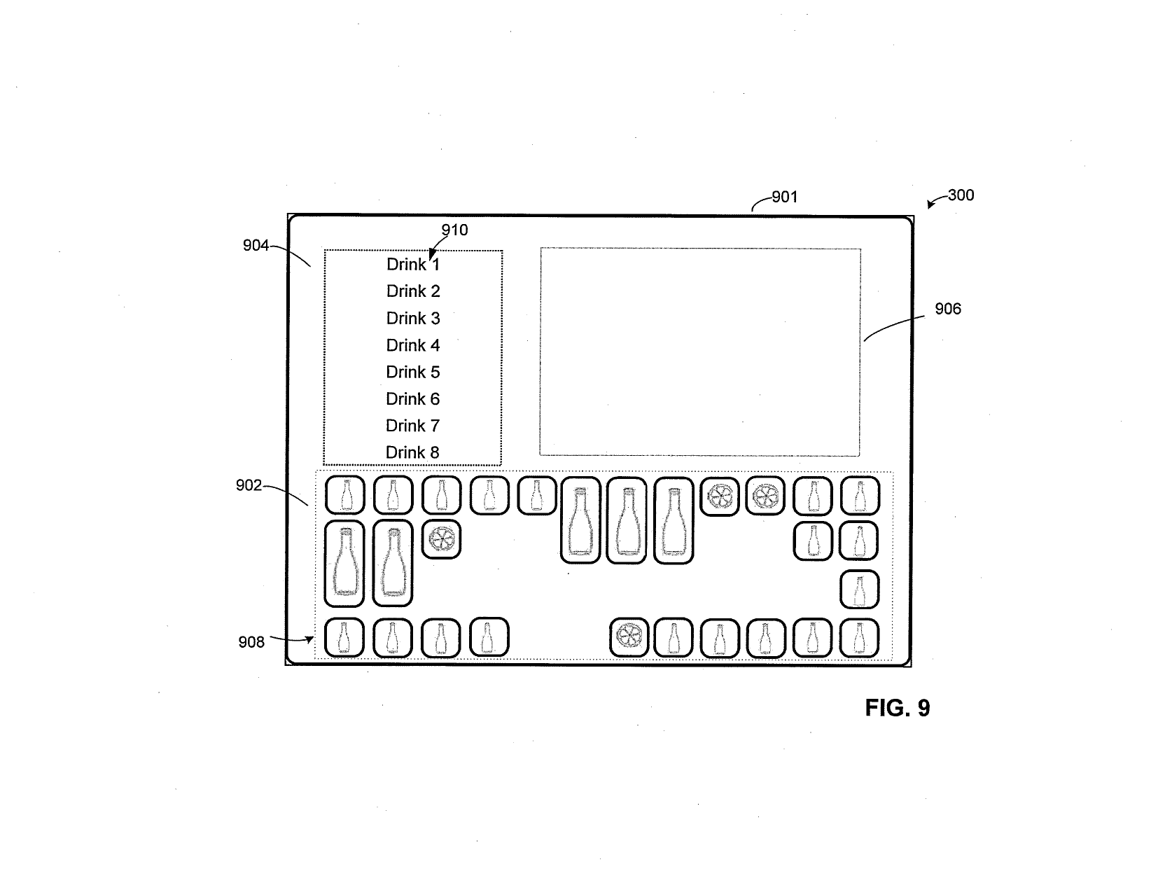

FIGS. 9-13 illustrate a graphical representation of an operational environment 901 of a food establishment including a drink preparation area which may simulate a preparation of a drink. Operational environment 901 may be presented on any suitable user interface, such as user interface 300 shown in FIGS. 3-8. A graphical representation of a process of preparation of a drink using the recipe system may be similar to the graphical representation of the process of preparation of recipe 402 described in connection with FIGS. 4-8 and therefore is not described herein in detail.

Similarly to operational environment 301 (FIG. 3), FIG. 9 shows that operational environment 901 may comprise areas 902, 904 and 906, with area 902 including ingredients 908 and area 904 including drink recipes 910.

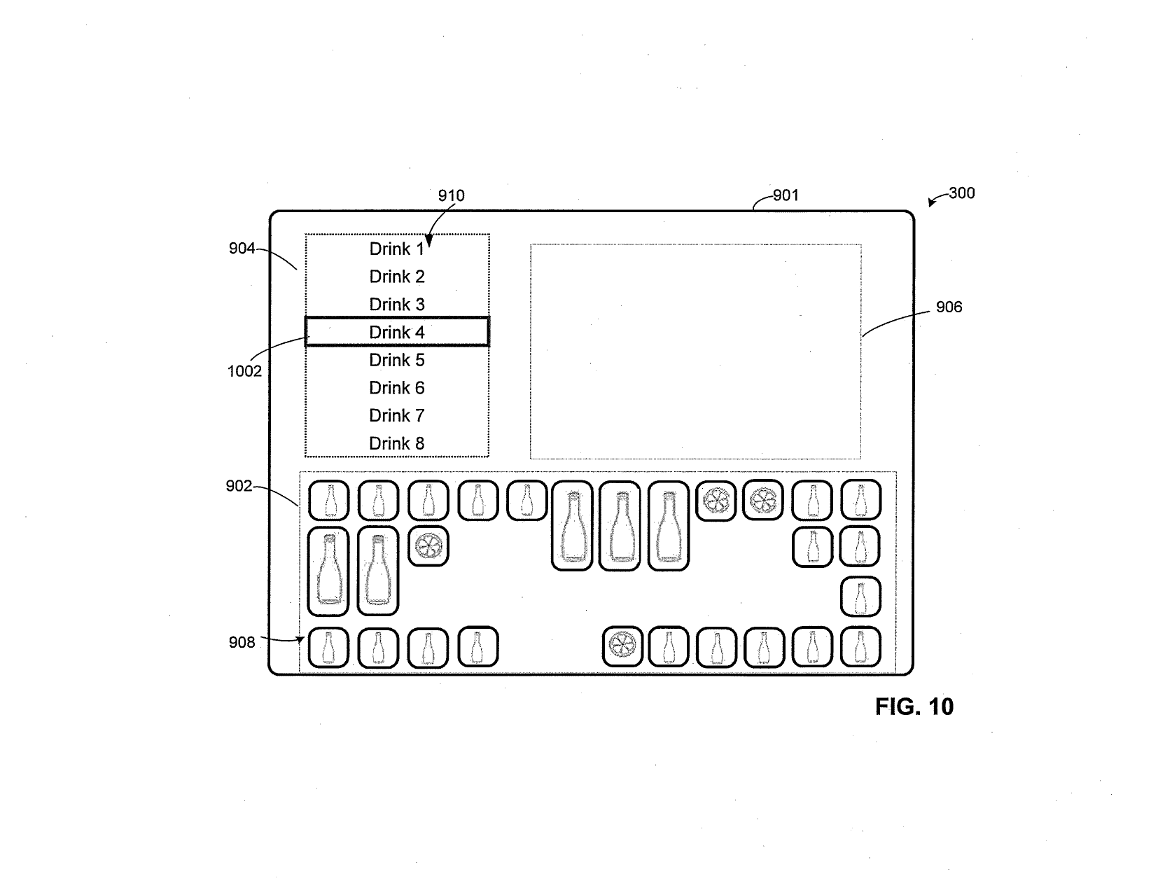

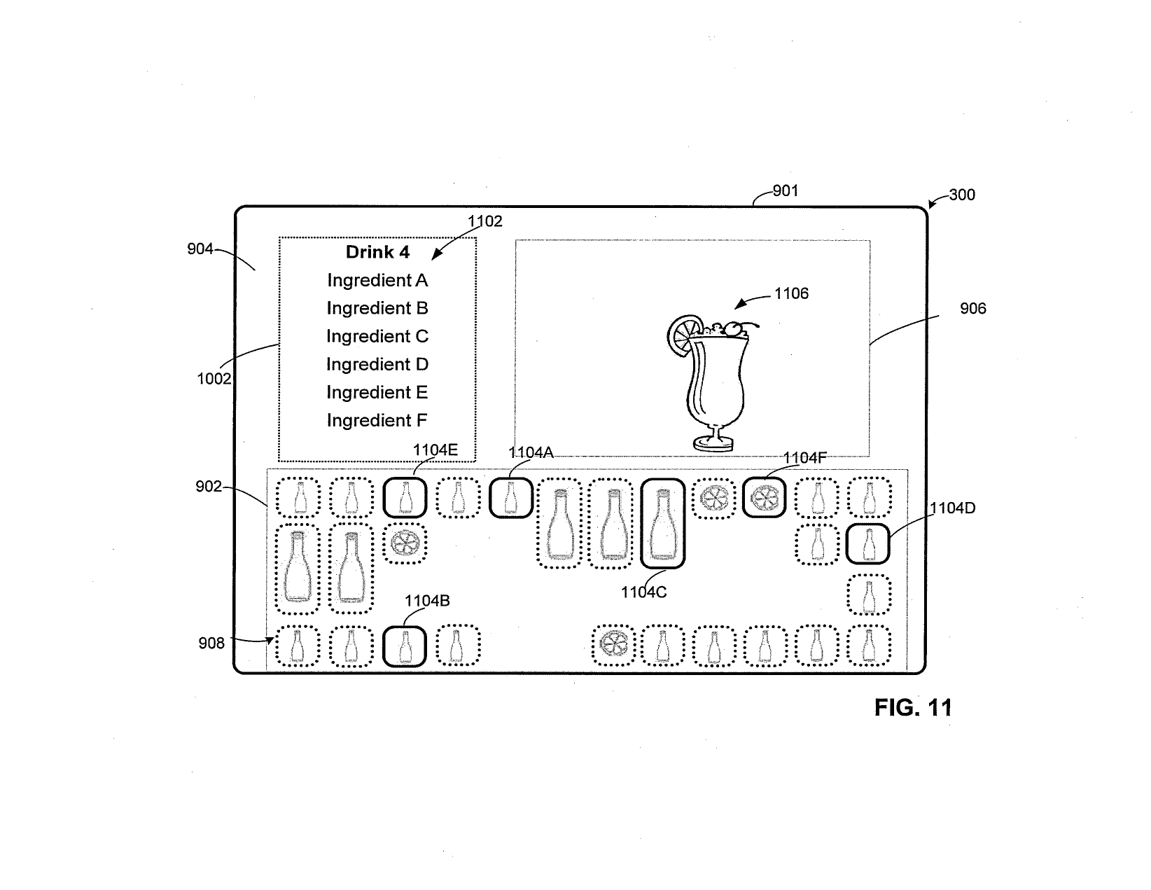

Further, similar to FIG. 4, FIG. 10 illustrates that a recipe for a drink (“Drink 4”) 1002 may be selected from drink recipes 910. Next, either in response to user input or any other suitable trigger, ingredients 1102 used in selected drink 1002 may be displayed in FIG. 11. Any other additional information on one or more ingredients used in recipe 1002 and/or a view of a partially or fully completed product may be displayed. Thus, FIG. 11 shows a final look 1106 of Drink 4 when prepared using recipe 1002. Furthermore, in FIG. 11, each of ingredients 1102 used in drink 1002 may be indicated among ingredients 908 so that, in the guidance mode, the user may easily determine a location of each of the ingredients in the actual operational environment. In the training mode and the efficiency estimation modes, the user may interact with the recipe system to simulate the preparation of the recipe. Moreover, in the training mode, the user may utilize the simulated operational environment of a food establishment to learn a location of each ingredient in the actual operational environment.

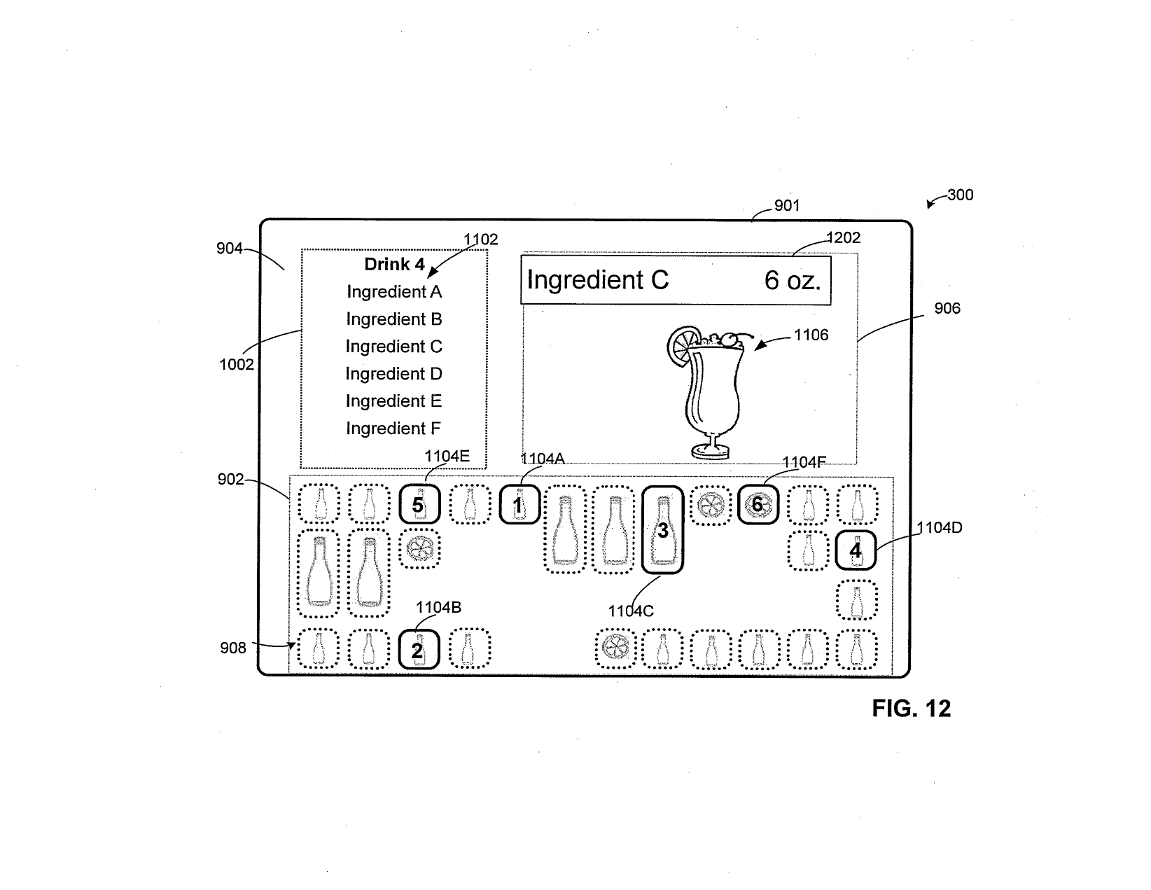

As shown in FIG. 11, ingredients 1102 used in recipe 1002 may comprise ingredients 1104A, 1104B, 1104C, 1104D, 1104E and 1104F. FIG. 12 further illustrates, similarly to FIG. 7, that an order of selection of ingredients during preparation of recipe 1002 may be indicated to the user. Thus, recipe 1002 for Drink 4 requires that ingredient 1104A be selected first, ingredient 1104B be selected second, ingredient 1104C be selected third, ingredient 1104D be selected fourth, ingredient 1104E be selected fifth, and ingredient 1104F be selected sixth. It should be appreciated that the ingredients 1104A, 1104B, 1104C, 1104D, 1104E and 1104F and an order of their selection are shown by way of example only, as the recipe system may provide a graphical representation of preparation any drink or meal comprising any number of ingredients assembled in any suitable order.

FIG. 12 also illustrates that additional information on an ingredient used in a recipe which preparation steps are currently displayed by the recipe system may be presented. Thus, in FIG. 12, information on ingredient C (1104C), such as its amount used in recipe 1002 (“6 oz.”) may be presented (1202). Any other suitable information used in preparation of recipe 1002 may be presented as well.

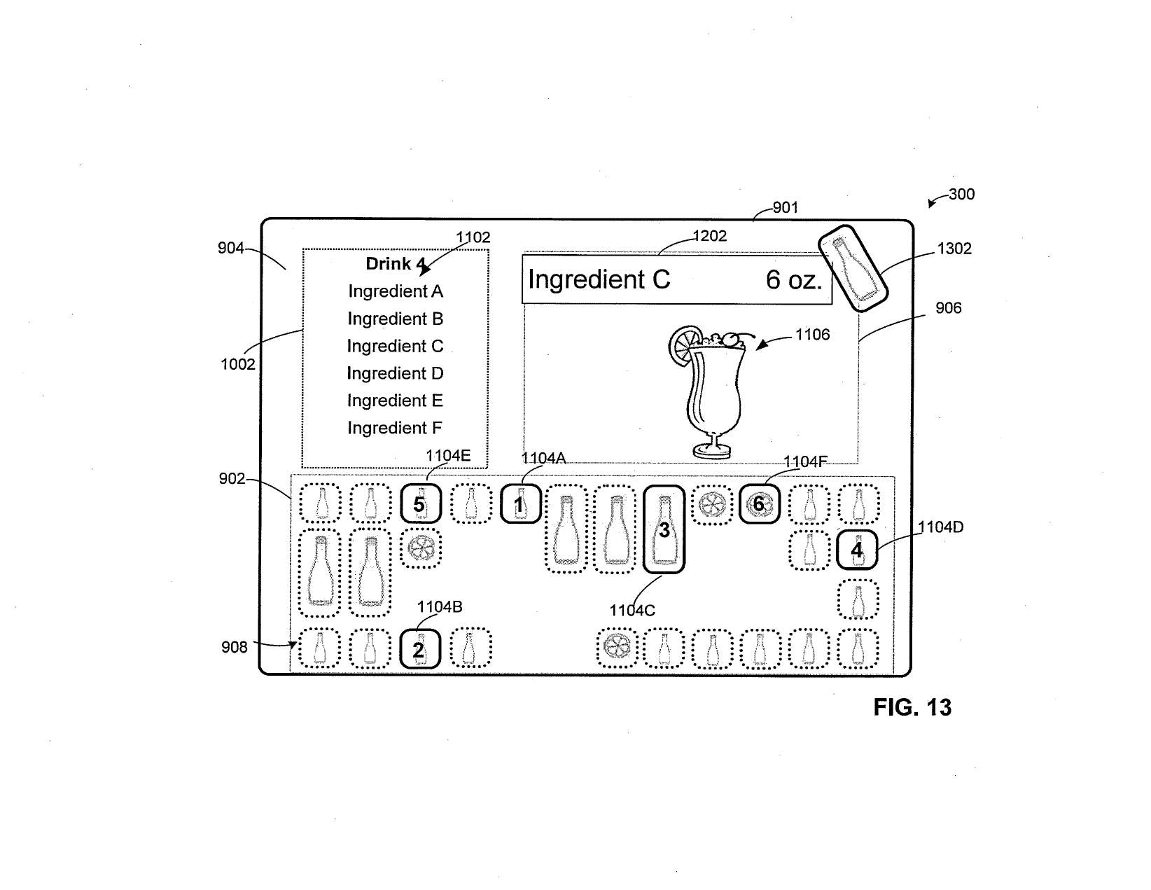

Additionally or alternatively, the recipe system may present on a user interface one or more visual indicators representing, in an intuitive fashion, steps in preparing a product according to a recipe. These visual indicators may include, for example, a tipping bottle, to represent an amount of a liquid ingredient to be taken to prepare a product. Thus, FIG. 13 depicts an example of such indicator 1302 indicating to the user a degree to which to tip ingredient C (1104C) which is, in this example, a bottle.

In the training mode, such an indicator may be used to simulate user's action of “pouring” ingredient C into a simulated container used to “prepare” Drink 4, as the user interacts in a suitable manner with operational environment 901. It should be appreciated that any other visual indicators that may assist the user to select an ingredient and incorporate the ingredient in a product may be presented by the recipe system.

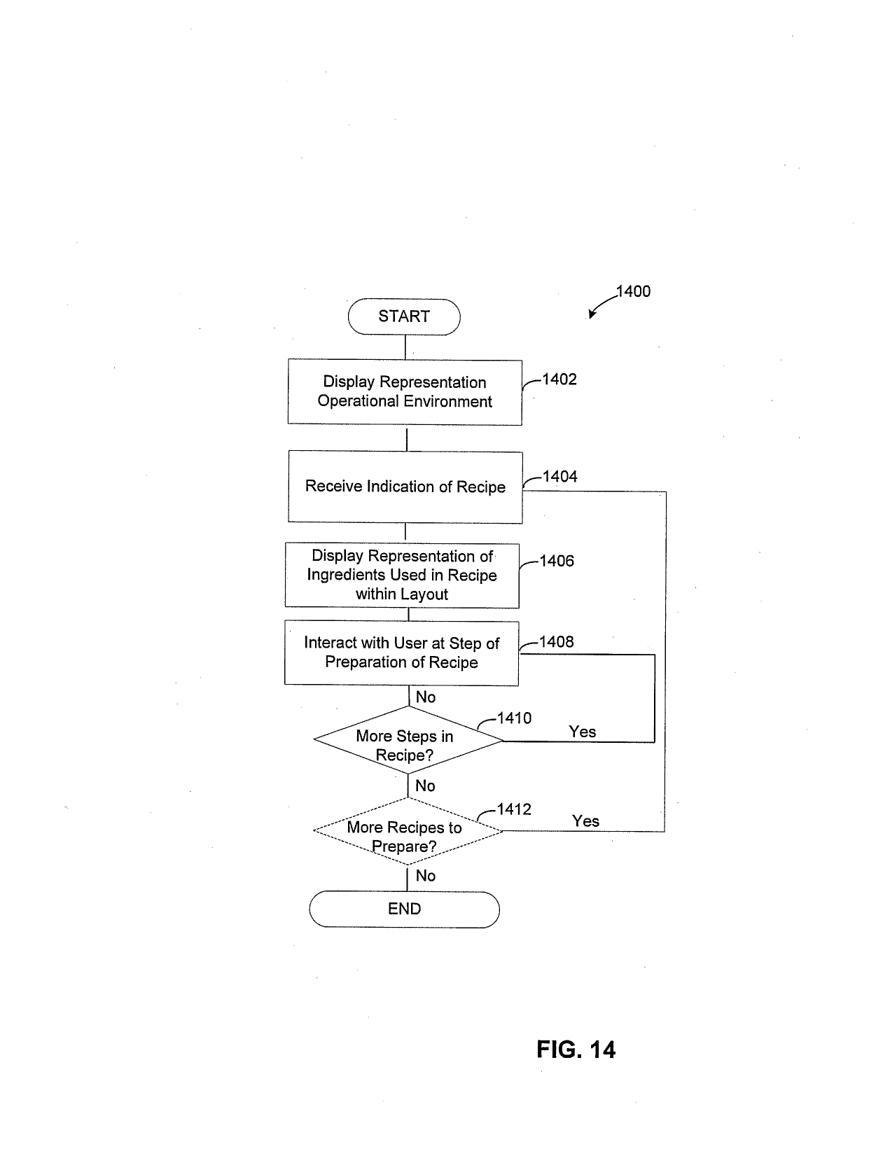

FIG. 14 illustrates a process 1400 of guiding a user through a preparation of a recipe using the recipe system. Process 1400 may be performed, for example, if the recipe system is operated in the guidance mode. Process 1400 may start at any suitable time. For example, process 1400 may start in response to a suitable user input instructing the recipe system to initiate.

Regardless of a way in which process 1400 is initiated, the recipe system may display, at block 1402, a graphical representation of a simulated operational environment of a food establishment. For example, a representation of an operational environment, such as shown in FIG. 3 or FIG. 9, may be provided. Though, any other suitable representations may be provided. The representation of the operational environment may be provided on a user interface, such as a graphical user interface 300 (FIGS. 3-13).

Next, at block 1404, the recipe system may receive an indication of a recipe. The indication of the recipe may be received in any suitable manner—e.g., a user input may be received, a suitable storage is accessed, or in any other suitable manner. FIGS. 4 and 10 illustrate examples of selection of a recipe from multiple recipes presented on a user interface.

After the indication of the recipe is received, process 1400 may proceed to block 1406 where a representation of ingredients used in the recipe may be selected. FIGS. 5 and 11 illustrate examples of such representation of ingredients used in a meal (FIG. 5) and a drink (FIG. 11).

At block 1408, the recipe system may interact with the user at a step of preparation of the recipe. In the guidance mode, the interaction of the recipe system with the user may include receiving user input regarding any visual item displayed as part of the representation of the operational environment. For example, user input indicating a selection of an ingredient from ingredients used in the recipe may be received. In response to such input, for example, additional information on the selected ingredient may be provided.

Furthermore, the recipe system may receive user input instructing the system to present another view of the representation of the operational environment. For example, user input with respect to a “Next” button 404 (FIG. 4) may be received. Though, the representation of the operational environment may include any other suitable controls as embodiments of the invention are not limited in this respect. For example, the recipe system may enable the user to go to a previous view of the representation of the operational environment.

Process 1400 may branch at block 1410 based on whether the process of preparation of the recipes includes one or more other steps. If it is determined that other step(s) are included in the preparation of the recipe, process 1400 may branch back to block 1408 where the recipe system may again interact with the user at the next step of preparation of the recipe. It should be appreciated that, in some embodiments, in the guidance mode, the interaction with the user may be limited—e.g., user input instructing a display of a next or a previous view of the representation of the operational environment may be received.

If it is determined, at block 1410, that the preparation of the recipe does not involve any other step(s), the preparation of the recipe may be completed. At this point, process 1400 may end.

In some embodiments, as shown in FIG. 14, process 1400 may be executed continuously. For example, a user, such as employee 106 (FIG. 1B), may utilize a device (e.g., device 108 in FIG. 1B) for guidance in preparation of multiple recipes in the actual operational environment of a food establishment, such as a restaurant. Accordingly, at optional block 1412, process 1400 may determine if there are more recipes to “prepare” in the simulated operational environment. If this is the case, process 1400 may branch to block 1404 where an indication of another recipe may be received. The user may then be guided through preparation of this recipe. If, however, it is determined that no other recipes are to be “prepared,” process 1400 may end.

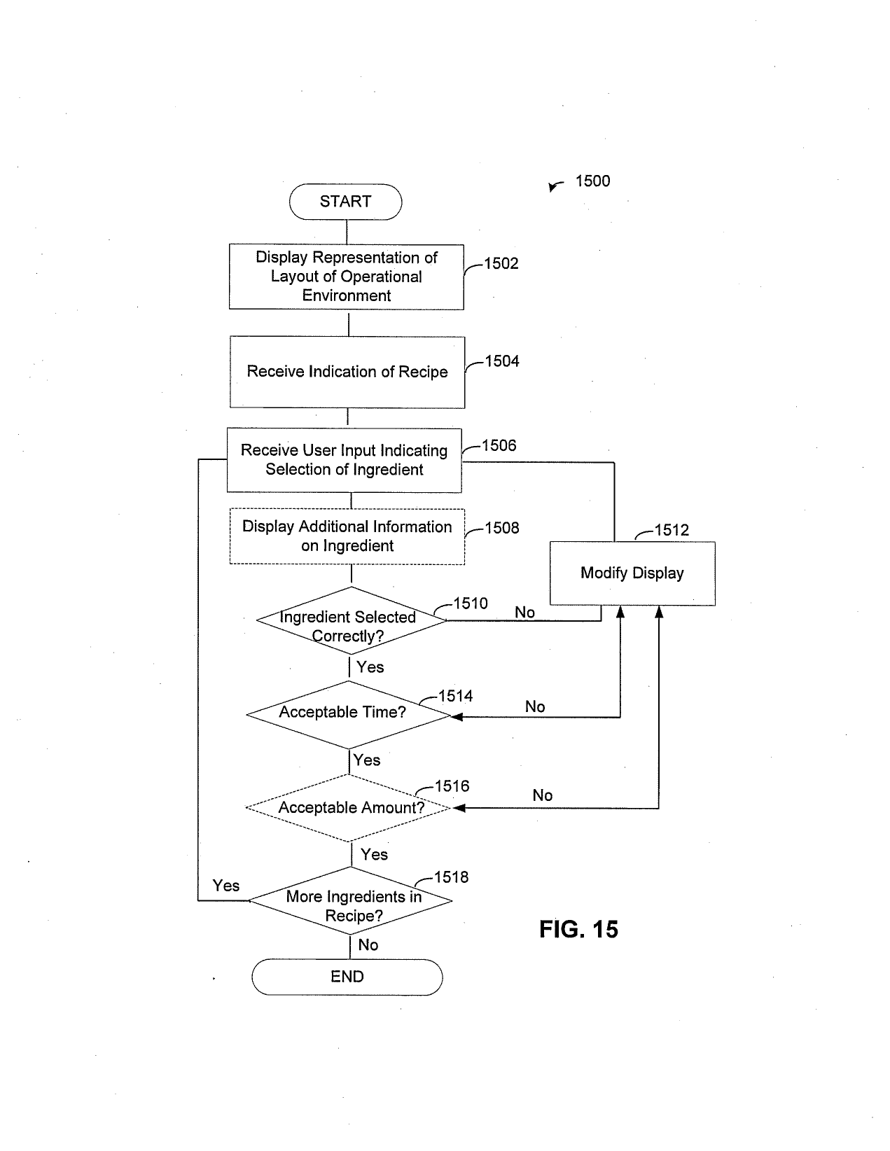

FIG. 15 is a flowchart illustrating a process 1500 of training a user to prepare a recipe using the recipe system, in accordance with some embodiments. Process 1500 may start at any suitable time. For example, process 1500 may start when execution of the recipe system is initiated, which may occur in response to user input or any other suitable trigger.

Regardless of a way in which process 1500 is initiated, the recipe system may display, at block 1502, a graphical representation of a simulated operational environment of a food establishment, such as a restaurant or any other suitable food establishment. The simulated operational environment may include multiple ingredients and other items each associated with a particular location within the operational environment.

For example, a representation of an operational environment such as the environment shown in FIG. 3 or FIG. 9 may be provided. Though, any other suitable representations may be provided. The representation of the operational environment may be provided on a user interface, such as a graphical user interface 300 (FIGS. 3-13).

Next, at block 1504, the recipe system may receive an indication of a recipe. The indication of the recipe may be received in any suitable manner—e.g., a user input may be received, a suitable storage is accessed, or in any other suitable manner. FIGS. 4 and 10 illustrate examples of selection of a recipe from multiple recipes presented on a user interface. In the training operating mode, a recipe may be indicated via user input. Furthermore, in some embodiments, the recipe for the user to learn may be selected by the recipe system.

In some embodiments, in response to receiving the indication of the recipe for a product, the recipe system may display ingredients used in the recipe. For example, ingredients for a meal or drink may be displayed, as illustrated in FIGS. 5 and 11, respectively. However, in other embodiments, in the training mode, the recipe system may not display ingredients used in the recipe so that the user's ability to “prepare” the recipe may be tested. Moreover, other scenarios are possible where, for example, only a hint on one or more ingredients used in the recipe may be provided to the user.

Regardless of a way the indication of the recipe is received, process 1500 may continue to block 1506 where user input indicating a selection of an ingredient from the ingredients used in the recipe may be received. As discussed above, the recipe system may display on the user interface ingredients used in the recipe, in which case the user may only need to correctly and quickly identify the ingredient to be selected among the ingredients within a layout of the operational environment. In other embodiments (e.g., at advanced stages of training the user to prepare the recipe), the ingredients used in the recipe may be not displayed and user's ability to remember an ingredient to select may be tested.

FIG. 15 illustrates that process 1500 may include optional block 1508 where additional information on the ingredient may be displayed on the user interface. The additional information may be any suitable information that may be useful to the user in “preparing” the recipe via the simulated operational environment.

Next, process may branch at decision block 1510 depending on whether the ingredient selected at block 1506 was selected correctly. The selection of the ingredient may include receiving by the recipe system suitable user input with respect to a graphical representation of an ingredient on the user interface. The user input may be in a form of touching, tapping or otherwise manipulating the graphical representation of the ingredient.

If it is determined, at block 1510, that the user input received with respect to a graphical representation of an ingredient on the user interface indicates a selection of the correct ingredient, process 1500 may branch to another decision block 1514. The selection of the correct ingredient may include a selection of an ingredient that, according to the recipe, is to be currently used in the recipe. For example, if the recipe indicated at block 1504 is for a salad, the ingredient to be currently used may be tomatoes.

Alternatively, if it is determined, at block 1510, that the user input received with respect to a graphical representation of an ingredient on the user interface does not indicate a selection of a correct ingredient, process 1500 may branch to block 1512 where the representation of the operational environment may be modified in a suitable manner. For example, the recipe system may indicate to the user that an error occurred. Also, a hint regarding a correct ingredient may be displayed. It should be appreciated that embodiments of the invention are not limited with respect to a way in which the representation of the operational environment of the food establishment may be modified when the user incorrectly “selects” an ingredient during simulation of preparation of the recipe. Next, from block 1510, process 1500 may return to block 1506 where user input indicating selection of an ingredient may again be received.

At decision block 1514, process 1500 may determine whether the ingredient has been selected with an acceptable time. In the training mode, the recipe system may monitor user's performance as the system interacts with the user. Different parameters of the user's performance may be tracked, such as a speed with which the user is able to select one or more ingredients, which may be the speed with which the user locates a representation of the ingredient on the user interface and touches the representation or otherwise indicates selection of the ingredient. The acceptable time may be any suitable time which may be set by the recipe system, by the user or in other suitable manner. The acceptable time may be a threshold that may be based, for example, on requirements of a food establishment or other factors that determine how quickly the user is expected to prepare a product from the recipe.

Any other suitable parameters of the user's performance may be tracked by the recipe system. Thus, FIG. 15 shows that, if it is determined at block 1514 that the ingredient has been selected with an acceptable time, process 1500 may continue to block 1516 where it may be determined whether an amount of the ingredient selected by the user via the simulated operational environment was acceptable.

If it is determined, at block 1514, that the ingredient has not been selected with an acceptable time, meaning that the user acted slower than required by the recipe system, process 1500 may branch to block 1512 where the representation of the operational environment may be modified in a suitable manner. The modification may include, for example, indicating to the user that the timing was not acceptable. Further, after an indication is provided to the user regarding the user's timing of the selection of the ingredient, process 1500 may continue to block 1516, as indicated in FIG. 15.

The processing at block 1516 may be optional, as indicated in FIG. 15. As discussed above, the recipe system may provide one or more controls through which user input may be received simulating manipulation of the ingredient, such as taking a certain amount, pouring a liquid ingredient or otherwise manipulating the ingredient or any other item used in the product or in preparation of the product. For example, if the ingredient is tomatoes, the recipe may require an amount of three slices. FIGS. 7, 8, 12 and 13 illustrate that the user interface may display a required amount of an ingredient.

The recipe system may track the user's performance with respect to such manipulations of the ingredient. Consequently, indicators of the user's performance regarding these controls may be displayed to the user. Thus, if it is determined, at block 1516, that an amount of the ingredient selected by the user was not acceptable, the recipe system may inform the user accordingly, at block 1512. Process 1500 may then follow to block 1518.

At block 1518, process 1500 may branch based on whether the recipe includes more ingredients. If more ingredients are to be “selected” by the user as part of the training process, process 1500 may return to block 1506 where user input with respect to a selection of other ingredient may be received. Process 1500 may thus iterate until it is determined, at block, 1518, that the preparation of the recipe is completed.

It should be appreciates that the recipe system may track user's performance with respect to any other aspects of the simulated preparation of the recipe. Furthermore, the recipe system may display to the user not only error or warning indicators. Additionally or alternatively, the system may display, at any step of the preparation of the recipe, indicators indicating that user's performance meets certain requirements. Furthermore, any indicators simply tracking user's actions may be presented.

The recipe system may operate in an efficiency evaluation mode. Thus,

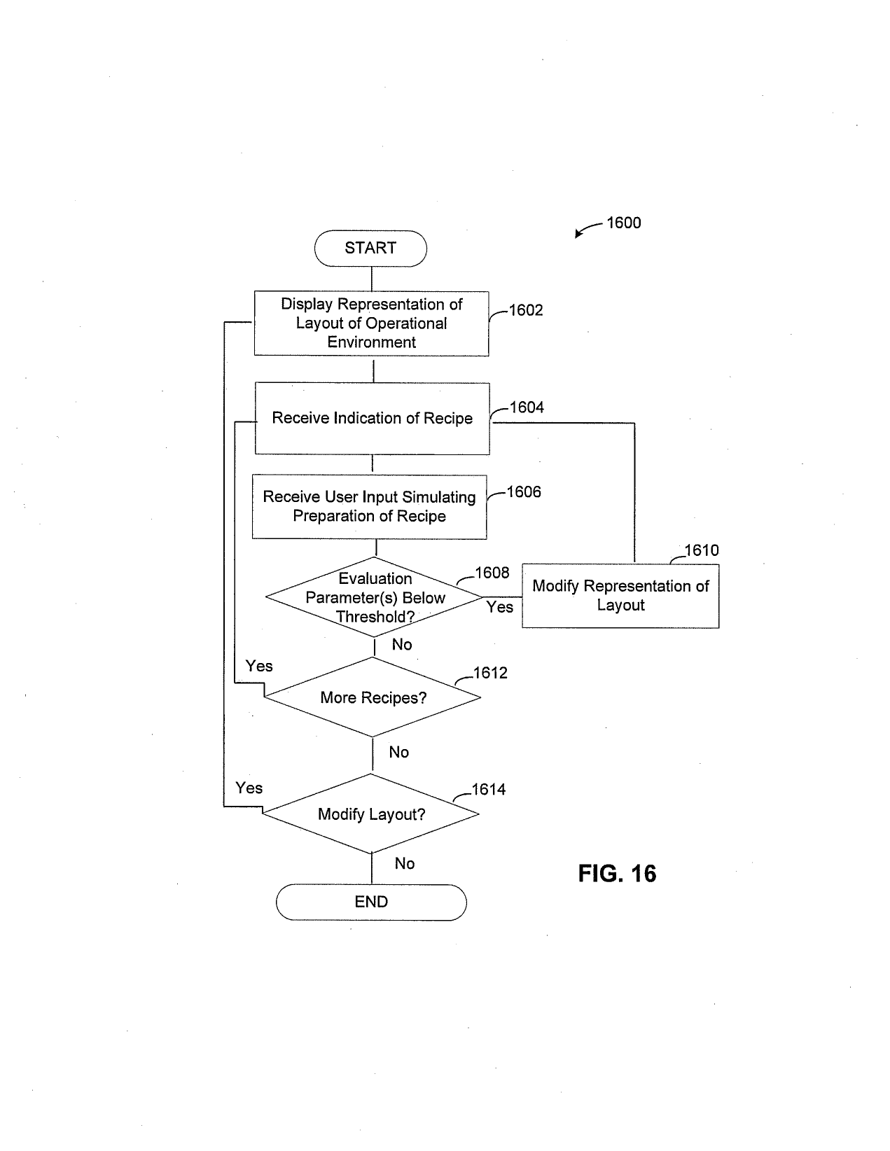

FIG. 16 illustrates a process of simulation and assessment of ergonomics of different layouts of ingredients in a food establishment, in accordance with some embodiments.

Process 1600 may start at any suitable time. For example, process 1600 may start when execution of the recipe system is initiated, which may occur in response to user input or any other suitable trigger.

Regardless of a way in which process 1600 is initiated, the recipe system may display, at block 1602, a graphical representation of a simulated operational environment of a food establishment, such as a restaurant or any other suitable food establishment. The simulated operational environment may include multiple ingredients and other items each associated with a particular location within the operational environment. The efficiency evaluation mode of the recipe system may be used to determine a layout of the ingredients that allows achieving a desirable performance of the operational environment of the food establishment.

For example, a representation of an operational environment such as the environment shown in FIG. 3 or FIG. 9 may be provided. Though, any other suitable representations may be provided. The representation of the operational environment may be provided on a user interface, such as a graphical user interface 300 (FIGS. 3-13).

Next, at block 1604, the recipe system may receive an indication of a recipe. The indication of the recipe may be received in any suitable manner—e.g., a user input may be received, a suitable storage is accessed, or in any other suitable manner. FIGS. 4 and 10 illustrate examples of selection of a recipe from multiple recipes presented on a user interface. The recipes may be recipes on a menu in the food establishment and the purpose of the efficiency evaluation mode may be to determine an arrangement of the ingredients and other items in the operational environment so that one or more employees may prepare the recipes on the menu in a timely manner.

At block 1606, user input simulating preparation of the recipe may be received. The user may be guided through the preparation, as in the guiding mode (FIG. 14) or provided with other ways to simulate preparation of the recipe. For example, the recipe system may provide a simulated operational environment that incorporates some features of the training mode and some features if the guidance mode.

Regardless of a way to enable the user to simulate preparation of the recipe, process 1600 may branch at block 1608, depending on whether one or more evaluation parameters of the user's performance are below a certain threshold. The evaluation parameters may be similar to the parameters of user's performance tested in the training mode, such as a correctness of a selection of an ingredient, a speed of the selection, etc. Any suitable evaluation parameters may be utilized to access an efficiency and ergonomics of the current layout. The recipe system may track a location of each item in the layout, as described in connection with FIG. 2.

If it is determined, at block 1608, that the one or more evaluation parameters of the user's performance are below a certain threshold, process 1600 may branch to block 1610 where the current layout of the ingredients may be modified in a suitable manner. The modification may include rearranging one or more ingredients or other items within the layout and may be done based on the evaluation of the user's performance assessed at block 1608. It should be appreciated that the modification may be performed based on more than one iteration of the process of user's simulating preparation of the recipes using the simulated layout, as shown below.

If it is determined, at block 1608, that the one or more evaluation parameters of the user's performance are not below a certain threshold, process 1600 may continue to block 1612 where it may branch based on whether more recipes may be “prepared” using the layout. If the efficiency evaluation process includes simulation of preparation of more recipes, process 1600 may return to block 1604 where an indication of another recipe may be selected. In some embodiments, preparation of more than one recipe may be simulated by the user to determine whether the current layout is deemed efficient for the food establishment. For example, the user may go through the simulation of preparation of some or all recipes on the menu in a restaurant to determine if the layout is efficient. Further, the recipe system may evaluate performance of more than one user during the process of the efficiency evaluation of the layout.

Accordingly, if it is determined at block 1612 that the simulation of the preparation of the recipes is completed, process 1600 may continue to block 1614 where it may be determined whether to modify the current layout. The modification may include rearranging one or more ingredients or other items (e.g., garnish, ice bucket, spices, etc.) within the layout and may be done based on the evaluation of the user's performance assessed, for one or more recipes, at block 1608.

The modification may be performed based on more than one iteration of the process of user's simulating preparation of the recipes using the simulated layout. In this way, preparation of more than one recipe may need to be simulated by the user before the current layout may be modified. Furthermore, information acquired from more than one user simulating preparation of the recipes using the simulated layout may be used in the modification. For example, if multiple users consistently exhibit a performance below a desired threshold while “preparing” a recipe using a certain layout, this may indicate that the layout is not efficient. Additionally or alternatively, the recipe may be modified.

If it is determined, at block 1614, that the current layout is to be modified, process 1600 may return to block 1602 where the evaluation of the efficiency of the modified layout may be performed. Process 1600 may thus iterate by evaluating efficiency of different layouts until a layout with a desired efficiency is determined.

Alternatively, when it is determined at block 1614 that the current layout may not need to be modified (i.e., it is deemed to be an efficient layout), process 1600 may end. It should be appreciated that, even when it is determined at block 1614 that the current layout is to be modified, in some scenarios, process 1600 may end.

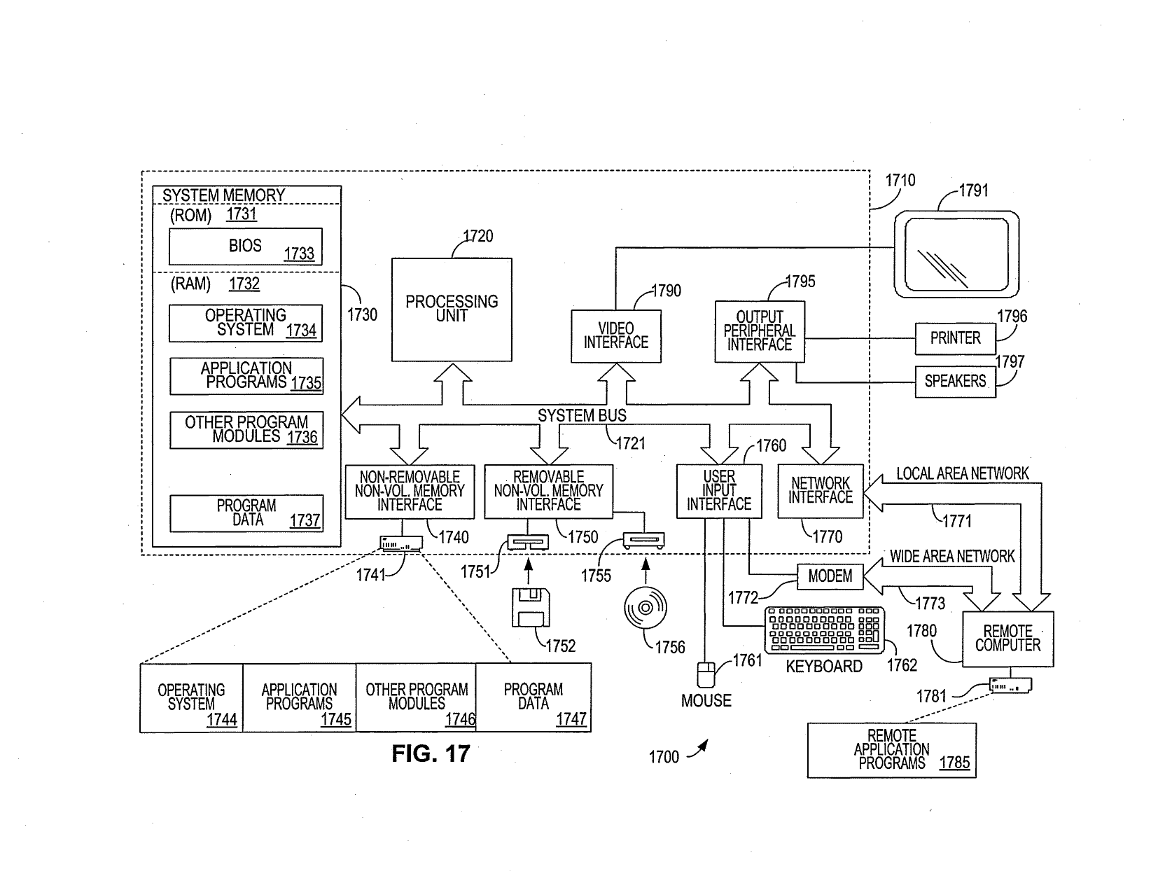

FIG. 17 illustrates an example of a suitable computing system environment 1700 on which some embodiments of the invention may be implemented. It should be appreciated that the computing system environment 1700 is only one example of a suitable computing environment and is not intended to suggest any limitation as to the scope of use or functionality of the invention. Neither should the computing environment 1700 be interpreted as having any dependency or requirement relating to any one or combination of components illustrated in the exemplary operating environment 1700.

Some embodiments of the invention are operational with numerous other general purpose or special purpose computing system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. Some embodiments of the invention may also be practiced in distributed computing environments where tasks are performed by remote processing devices that are linked through a communications network. In a distributed computing environment, program modules may be located in both local and remote computer storage media including memory storage devices.

With reference to FIG. 17, an exemplary system for implementing some embodiments of the invention includes a general purpose computing device in the form of a computer 1710. Components of computer 1710 may include, but are not limited to, a processing unit 1720, a system memory 1730, and a system bus 1721 that couples various system components including the system memory to the processing unit 1720. The system bus 1721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1710 typically includes a variety of computer readable media. Computer readable media can be any available media that can be accessed by computer 1710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1730 includes computer storage media in the form of volatile and/or nonvolatile memory such as read only memory (ROM) 1731 and random access memory (RAM) 1732. A basic input/output system 1733 (BIOS), containing the basic routines that help to transfer information between elements within computer 1710, such as during start-up, is typically stored in ROM 1731. RAM 1732 typically contains data and/or program modules that are immediately accessible to and/or presently being operated on by processing unit 1720. By way of example, and not limitation, FIG. 17 illustrates operating system 1734, application programs 1735, other program modules 1736, and program data 1737.

The computer 1710 may also include other removable/non-removable, volatile/nonvolatile computer storage media. By way of example only, FIG. 17 illustrates a hard disk drive 1740 that reads from or writes to non-removable, nonvolatile magnetic media, a magnetic disk drive 1751 that reads from or writes to a removable, nonvolatile magnetic disk 1752, and an optical disk drive 1755 that reads from or writes to a removable, nonvolatile optical disk 1756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1741 is typically connected to the system bus 1721 through a non-removable memory interface such as interface 1740, and magnetic disk drive 1751 and optical disk drive 1755 are typically connected to the system bus 1721 by a removable memory interface, such as interface 1750.

The drives and their associated computer storage media discussed above and illustrated in FIG. 17, provide storage of computer readable instructions, data structures, program modules and other data for the computer 1710. In FIG. 17, for example, hard disk drive 1741 is illustrated as storing operating system 1744, application programs 1745, other program modules 1746, and program data 1747. Note that these components can either be the same as or different from operating system 1734, application programs 1735, other program modules 1736, and program data 1737. Operating system 1744, application programs 1745, other program modules 1746, and program data 1747 are given different numbers here to illustrate that, at a minimum, they are different copies. A user may enter commands and information into the computer 1710 through input devices such as a keyboard 1762 and pointing device 1761, commonly referred to as a mouse, trackball or touch pad. Other input devices (not shown) may include a microphone, joystick, game pad, satellite dish, scanner, or the like. These and other input devices are often connected to the processing unit 1720 through a user input interface 1760 that is coupled to the system bus, but may be connected by other interface and bus structures, such as a parallel port, game port or a universal serial bus (USB). A monitor 1791 or other type of display device is also connected to the system bus 1721 via an interface, such as a video interface 1790. In addition to the monitor, computers may also include other peripheral output devices such as speakers 1797 and printer 1796, which may be connected through an output peripheral interface 1795.

The computer 1710 may operate in a networked environment using logical connections to one or more remote computers, such as a remote computer 1780. The remote computer 1780 may be a personal computer, a server, a router, a network PC, a peer device or other common network node, and typically includes many or all of the elements described above relative to the computer 1710, although only a memory storage device 1781 has been illustrated in FIG. 17. The logical connections depicted in FIG. 17 include a local area network (LAN) 1771 and a wide area network (WAN) 1773, but may also include other networks. Such networking environments are commonplace in offices, enterprise-wide computer networks, intranets and the Internet.

When used in a LAN networking environment, the computer 1710 is connected to the LAN 1771 through a network interface or adapter 1770. When used in a WAN networking environment, the computer 1710 typically includes a modem 1772 or other means for establishing communications over the WAN 1773, such as the Internet. The modem 1772, which may be internal or external, may be connected to the system bus 1721 via the user input interface 1760, or other appropriate mechanism. In a networked environment, program modules depicted relative to the computer 1710, or portions thereof, may be stored in the remote memory storage device. By way of example, and not limitation, FIG. 17 illustrates remote application programs 1785 as residing on memory device 1781. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

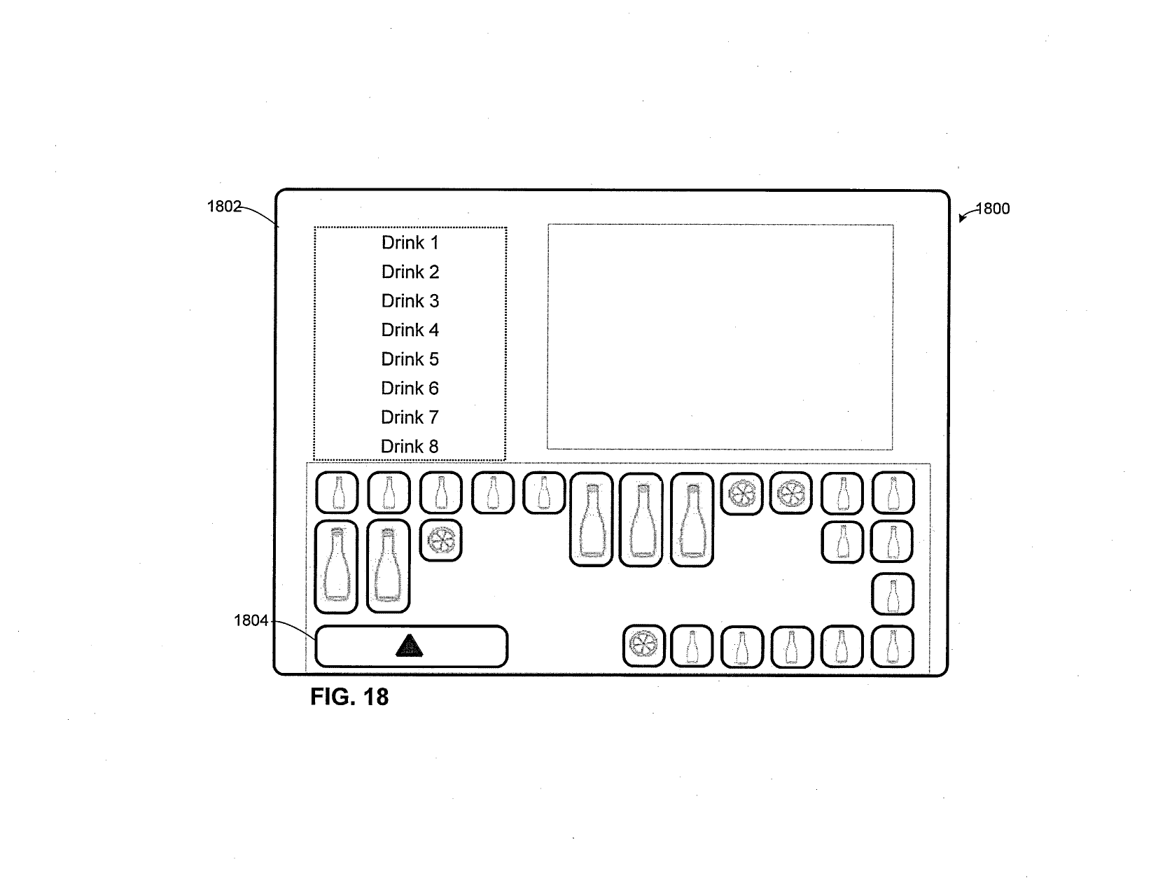

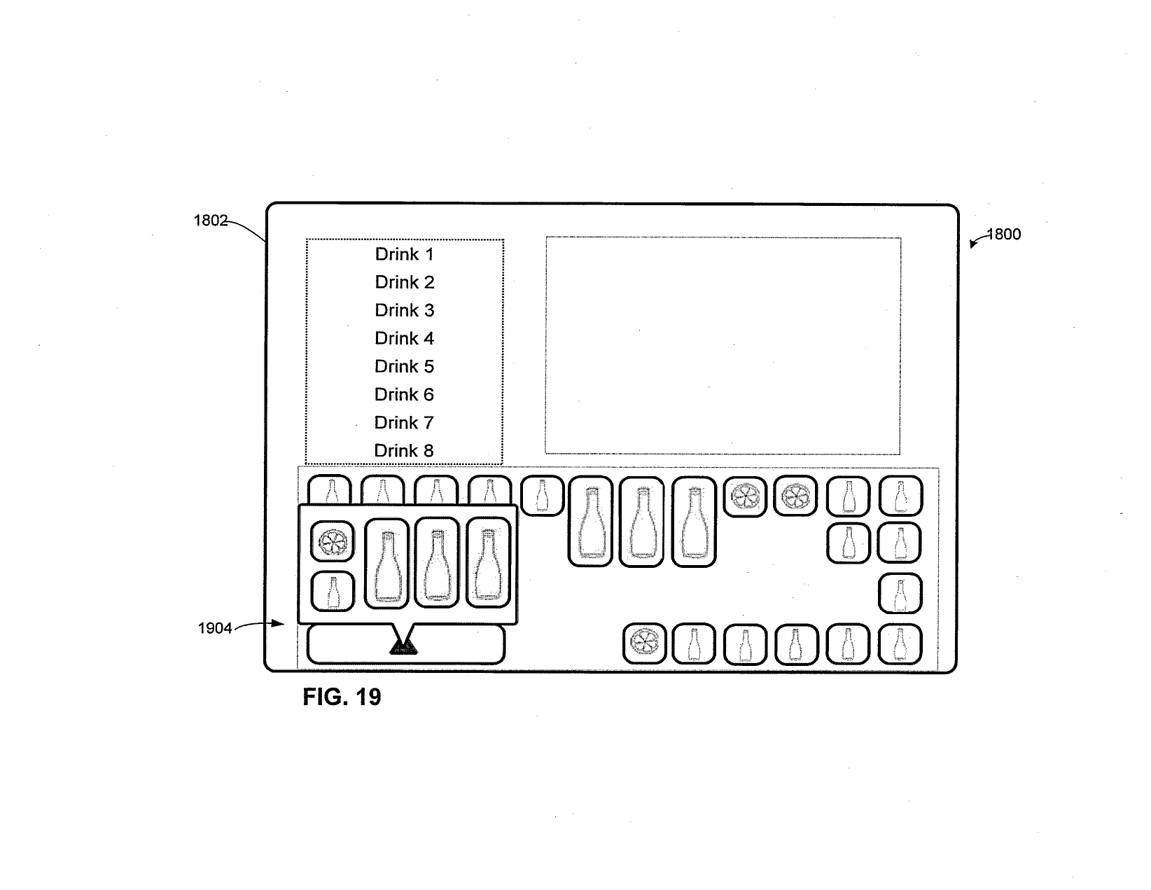

FIGS. 18 and 19 illustrate an example of an additional feature that may be implemented in the recipe system in some embodiments. FIG. 18 depicts a graphical user interface 1800 providing a simulated operational environment 1802. Operational environment 1802 may be, for example, any of the environments shown in FIGS. 3-13 or any other environment. As shown in FIG. 18, operational environment 1802 may include an item 1804 which may be referred to as a “drawer” that simulates an actual drawer in an actual operational environment simulated via operational environment 1802.

A suitable user input may be received with respect to item 1804. The user input may, for example, simulate opening or closing of the “drawer” item 1804. Hence, FIG. 19 shows a modified representation 1904 of the “drawer” item 1804 where the “drawer” was “opened” and content of the “drawer” is displayed. Such feature may be used in any of the operating mode of the recipe system.

It should be appreciated that the “drawer” item 1804 (and its modified representation 1904) is only one example of an item in an operational environment of a food establishment that may be simulated by the recipe system, as any other items that are used in an actual food or drink preparation area, such as shelves, racks, cabinets or any other appropriate space, may be graphically represented by the recipe system described herein. The recipe system may be used to simulate any suitable action with respect to such items. Each item may be associated with a location within the simulated operational environment, as described in connection with FIG. 2.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable storage medium or media can be transportable, such that the program or programs stored thereon can be loaded onto one or more different computers or other processors to implement various aspects of the present invention as discussed above. As used herein, the term “non-transitory computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computing device comprising at least one processor, the method comprising, with the at least one processor:
providing, on a user interface, a graphical representation of an operational environment of a food establishment, the graphical representation comprising a layout of a plurality of ingredients; and
for a recipe associated with a set of ingredients of the plurality of ingredients, interacting with a user to simulate a process of preparation of a product described in the recipe from the set of ingredients, using the graphical representation.

2. The method of claim 1, further comprising:
receiving an indication of the recipe by receiving user input indicating a selection of the recipe from a plurality of recipes displayed on the user interface.

3. The method of claim 1, wherein interacting with the user comprises:
receiving user input indicating a selection of at least one ingredient from the plurality of ingredients; and
in response to the user input, modifying the graphical representation.

4. The method of claim 3, wherein:
the recipe is associated with a threshold time to prepare the recipe; and
modifying the graphical representation comprises modifying the graphical representation based on a comparison of a duration of time required by the user to select the at least one ingredient and the threshold time.

5. The method of claim 3, wherein:
modifying the graphical representation comprises modifying the graphical representation based on whether the at least one ingredient is included in the set of ingredients.

6. The method of claim 2, further comprising:
in response to receiving the user input indicating the selection of the recipe, displaying the set of ingredients.

7. The method of claim 6, further comprising:
indicating to the user at least one ingredient from the set of ingredients to select.

8. The method of claim 1, wherein interacting with the user comprises:
indicating to the user an ingredient from the set of ingredients to select; and
in response to user input indicating a selection of the indicated ingredient, indicating to the user another ingredient from the set of ingredients to select.

9. The method of claim 8, wherein:
indicating to the user the at least one ingredient comprises displaying the at least one ingredient so that the at least one ingredient overlays at least one other ingredient from the plurality of ingredients in the graphical representation.

10. The method of claim 8, further comprising:
providing information on the at least one indicated ingredient, the information comprising:
at least one name associated with the at least one indicated ingredient;
at least one quantity associated with the at least one indicated ingredient;
at least one image of the at least one indicated ingredient;
at least one operation associated with the at least one indicated ingredient; and/or
at least one order/step number associated with the at least one indicated ingredient.

11. The method of claim 1, wherein:
the recipe is further associated with at least one modification to the set of ingredients, the at least one modification comprising at least one of adding, deleting or substituting an ingredient.

12. The method of claim 1, wherein:
providing the graphical representation comprises providing the graphical representation on a display; and
the display is configured to receive the user input comprising at least one of touching and gesturing.

13. A method of operating a computer comprising at least one processor, the method comprising, with the at least one processor:
providing a graphical representation of a first layout of a plurality of ingredients;
receiving user input with respect to the graphical representation of the first layout, the user input indicating selection of a set of ingredients of the plurality of ingredients to simulate preparation of at least one recipe associated with the set of ingredients; and
modifying the graphical representation of the first layout based on the received user input to provide a graphical representation of a second layout, wherein at least one ingredient from the plurality of ingredients has a position in the graphical representation of the second layout that is different from a position of the at least one ingredient in the graphical representation of the first layout.

14. The method of claim 13, further comprising:
receiving user input comprises receiving user input from a plurality of users.

15. The method of claim 13, wherein:
modifying the graphical representation of the first layout when the received user input is associated with a duration of time indicating the selection of the set of ingredients that is higher than a threshold time.

16. The method of claim 13, further comprising:
receiving user input with respect to the graphical representation of the second layout, the user input indicating selection of a set of ingredients of the plurality of ingredients to simulate preparation of at least one recipe associated with the set of ingredients; and
modifying the graphical representation of the second layout based on the received user input to provide a graphical representation of a third layout, wherein at least one second ingredient from the plurality of ingredients has a position in the graphical representation of the third layout that is different from a position of the at least one second ingredient in the graphical representation of the second layout.

17. A method of providing a user interface comprising:
creating at least one data structure representing an item in a visual representation of an operational environment of a restaurant, the at least one data structure comprising a plurality of parameters; and
with at least one processor:
accessing the plurality of parameters to create a representation of the item on the user interface; and
interacting with a user to receive user input with respect to the representation of the item on the user interface.

18. The method of claim 17, wherein the item comprises at least one ingredient.

19. The method of claim 17, wherein the plurality of parameters comprise at least one name of the item, at least one image of the item, at least one quantity of the item, at least one location of the item within the operational environment, at least one shape of a visible area of the item, and/or at least one order/step number associated with the item.

20. The method of claim 20, wherein the location of the item comprises a distance of the representation of the item from a reference point in the operational environment and a size of the visible area of the item.

21. The method of claim 19, wherein the location is specified in a two- or higher-dimensional coordinate system.

22. The method of claim 17, wherein interacting with the user to receive the user input comprises receiving user input simulating using the item in at least one recipe.

23. A system for simulation of recipe preparation, the system comprising:
a device comprising at least one processor configured to implement a method of simulating preparation of a recipe in an operational environment of a restaurant, the method comprising:
providing a graphical representation of the operational environment comprising a plurality of ingredients;
in a first operating mode, interacting with a user to guide the user through preparation of at least one recipe from at least one of the plurality of ingredients, using the graphical representation; and
in a second operating mode, interacting with the user to train the user to prepare the at least one recipe from at least one of the plurality of ingredients, using the graphical representation.

24. The system of claim 23, wherein the method further comprises:
in a third operating mode,
interacting with the user to receive user input simulating preparation of the at least one recipe from at least one of the plurality of ingredients using the graphical representation;
evaluating at least one parameter relating to the received user input simulating preparation of the at least one recipe; and
modifying a position of at least one ingredient from the plurality of ingredients to provide a modified graphical representation of the operational environment, based on the evaluation of the at least one parameter.
